(19) United States
(12) Patent Application Publication
(10) Pub. No.: US 2018/0177143 A1
(43) Pub. Date: Jun. 28, 2018

(54) SOILLESS PRE-VEGETATED MAT AND PROCESS FOR PRODUCTION THEREOF

(71) Applicant: University of Guelph, Guelph (CA)

(72) Inventors: Greg Yuristy, Guelph (CA); Youbin Zheng, Puslinch (CA); Mike Dixon, Guelph (CA)

(73) Assignee: University of Guelph, Guelph (CA)

(21) Appl. No.: 15/897,919

(22) Filed: Feb. 15, 2018

Related U.S. Application Data
(62) Division of application No. 14/761,644, filed on Jul. 17, 2015, now abandoned.
(60) Provisional application No. 61/759,633, filed on Feb. 1, 2013.

(51) Int. Cl. A01G 20/10; C05B 17/00; A01G 31/00; A01G 20/20; A01G 24/00

(52) U.S. Cl. CPC A01G 20/10; C05B 17/00; Y02P 60/216; A01G 20/20; A01G 24/00; A01G 31/00

(57) ABSTRACT

The present application relates to novel soilless pre-vegetated mats comprising a carrier mat comprised of a material that does not degrade under exterior growing conditions, and vegetation whose roots intertwine within and under the carrier mat. The present application also relates to processes for production of the soilless pre-vegetated mats.

The present application is a divisional of copending U.S. patent application Ser. No. 14/761,644, filed on Jul. 17, 2015, which is a National Stage of International Application No. PCT/CA2014/050064 filed Jan. 31, 2014, which claims the benefit of priority from U.S. Provisional Patent Application No. 61/759,633 filed on Feb. 1, 2013, the contents of each of which is incorporated by reference in their entirety.

### FIELD OF THE APPLICATION

The present invention relates to novel soilless pre-vegetated mats for use, for example, in green roof plant establishment, erosion control and ornamental plant production applications, and to processes for production thereof.

### BACKGROUND OF THE APPLICATION

Multiple options for the establishment of vegetation on green roofs are available to persons such as contractors and landscapers. The use of pre-vegetated systems has proved to be a popular option for planting, as such systems provide an “instant” green roof, allowing the benefits associated with green roof use to be available immediately from the time of installation. Using pre-vegetated systems also reduces the typical labour associated with maintaining and establishing a plant community.

Two systems of pre-vegetated plant production which presently dominate the industry are tray systems and mat systems; both of which are typically grown off site in a production facility, for example a nursery, then later moved to the site of the green roof. Tray systems typically involve a plastic, metal, or PVC tray which contains both the substrate and the plant material. The use of pre-vegetated matting has emerged as a popular alternative to the tray systems. While known examples of pre-vegetated mat systems differ, for example, in the features discussed below, such systems all comprise a mat.

Pre-vegetated mats are typically grown at production facilities, for example, nurseries, off-site from the site of the future green roof. Known examples of pre-vegetated mats comprise interwoven nylon or plastic mesh 1 cm thick, affixed to a geotextile material or coir mat which is used as a base material or carrier mat on which a growing substrate is placed on top. Cuttings from, for example Sedum plants or seeds of other plants, for example, herbaceous plants are then grown on the substrate.

When harvested, the above-described pre-vegetated mats are, for example, cut into about 1 m² sections or smaller and rolled up similar to a grass sod product. Typical weights for these squares range from about 18 to 30 kg/m² depending on the moisture content of the substrate and/or substrate type. In the production of known pre-vegetated mats, planting occurs in the spring and early summer for an anticipated sale the following year or at the end of the growing season. Common pre-vegetated mat planting methods comprise the application of seeds or plant cuttings. To establish a Sedum blanket using cuttings, typical cutting application loadings within the industry are presently about ¼ lb/ft² (1.24 kg/m²). Harvesting of the pre-vegetated mats includes cutting the mat to size, rolling the mat, and placing the mat on a truck for shipping. Extensive labor is associated with this method of production, which is reflected in the retail cost of the final product.

One trend in North America is to place the pre-vegetated mats onto a layer of substrate of varying depth. This is done to ensure survivability, and to maximize the benefits associated with green roof technologies in urban environments.

U.S. Pat. No. 4,232,481 (Chamoulaud) discloses a common method for growing pre-vegetated mats wherein a growing substrate is placed on plastic with the plants growing in the substrate. Some modifications in respect to addition of a carrier layer have also been disclosed (see, for example: U.S. Pat. No. 4,941,282; U.S. Pat. No. 5,555,674; U.S. Pat. No. 7,334,376; and U.S. Pat. No. 5,346,514) which have become common in green roof mat production. Other modifications which have been reported include the addition of “soilless” growing mixtures composed of sand for sod/mat production (see, for example: U.S. Pat. No. 6,532,697; and U.S. Pat. No. 5,301,466). Truly soilless methods of producing grass sod from sprigs also have been disclosed (see, for example: U.S. Pat. No. 6,357,176). However, the scope of their application is limited, as is the flexibility in plant selection.

Further, the base mat of the pre-vegetated mats of U.S. Pat. No. 6,357,176 is made of bio-cellulosic fiber and may contain other types of fiber, such as wood fibers or synthetic organic fibers. A pre-vegetated mat made of wood fiber or similar natural or synthetic organic materials would be expected to decompose rapidly, for example in about 1 to 2 years, rendering such a pre-vegetated mat unable to suppress the growth of underlying weeds.

Erosion control systems comprising a pre-vegetated mat are also known. Erosion control systems such as those disclosed in U.S. Pat. No. 7,828,499 to Carpenter and U.S. Pat. No. 5,358,356 to Romanek et al. often require the use of an anchoring system to affix the mat to the soil surface (see, for example: U.S. Pat. No. 7,862,259 to Carpenter; U.S. Pat. No. 6,171,022 to Decker) until plants can be grown, permanently adhering the system together.

### SUMMARY OF THE APPLICATION

In the present application, soilless pre-vegetated mats have been prepared. A number of benefits of the mats of the present application, and processes for their preparation, have been demonstrated and/or are expected over other known mats for producing green roof mat systems and/or mat systems for other purposes. For example, the mats of the present application have shown weed suppression. Because the soilless pre-vegetated mats of the present application have a carrier mat comprised of a material that does not degrade under exterior growing conditions, the weed suppression is expected to be long-term. For example, the weed suppression is expected to last longer than that expected for pre-vegetated mats comprising a carrier mat that degrades under exterior growing conditions. Further, the processes for producing the mats of the present application have been demonstrated to have comparatively rapid production times over existing processes for producing pre-vegetated mats. The processes for producing the mats of the present application also have been shown to result in significant water and nutrient use reductions during production over known systems. The mats of the present application are expected to be flexible in terms of location for production, and have been demonstrated to be flexible in terms of the vegetation species and vegetation species combinations which can be used. The mats of the present application also have a significantly reduced cost of production. The processes of the present application and the soilless pre-vegetated mats produced from such processes also do not result in any detectable damage to the roots of vegetation in the soilless pre-vegetated mats or restriction of their growth.

Accordingly, the present application includes a process for producing a pre-vegetated mat, comprising:
depositing a carrier mixture comprising vegetation propagation material suspended in an aqueous solution comprising a tackifying agent and a water-absorbing polymer on a carrier mat that does not degrade under exterior growing conditions; and
subjecting the carrier mixture on the carrier mat to hydroponic growing conditions,
wherein the pre-vegetated mat is soilless.

In the present application, soilless pre-vegetated mats have been produced using the processes described herein. A number of benefits of the soilless pre-vegetated mats of the present application have been shown and/or are expected over other known mats, such as other pre-vegetated mats. For example, the use of a polyethylene terephthalate (PET), or other similar material, carrier mat in the soilless pre-vegetated mats of the present application has been shown to result in weed suppression because weeds or weed seeds existing in the substrate which the mat is placed over, cannot penetrate the PET; nor can weed seeds dropping on the mat from the environment propagate because their roots cannot access the soil below the mat. Weeds are also restricted in their growth because the soilless pre-vegetated mat is fully propagated therefore the weeds must compete with the established plants of the soilless pre-vegetated mat. Further, the soilless pre-vegetated mats of the present application are lighter in weight than known mats, which speeds up harvesting and installation, and allows for a greater shipping capacity on weight-restricted vehicles. The soilless pre-vegetated mats of the present application are flexible in terms of plant species and plant species combinations. When PET is used for the carrier mat, the soilless pre-vegetated mats of the present application can be produced from 100% recycled materials. The lack of soil also allows for easier international shipment.

Accordingly, the present application includes a pre-vegetated mat, comprising, consisting of or consisting essentially of:
a carrier mat comprised of a material that does not degrade under exterior growing conditions; and
vegetation whose roots intertwine within and under the carrier mat,
wherein the pre-vegetated mat is soilless.

The present application also includes a soilless pre-vegetated mat produced by the processes of the present application.

Other features and advantages of the present application will become apparent from the following detailed description. It should be understood, however, that the scope of the claims should not be limited by the embodiments set forth in the examples, but should be given the broadest interpretation consistent with the description as a whole.

### BRIEF DESCRIPTION OF THE DRAWINGS

The present application will now be described in greater detail with reference to the drawings in which:

FIG. 1 shows a section of a soilless pre-vegetated mat production system according to an embodiment of the present application.

FIG. 2 shows a growing apparatus for the production of soilless pre-vegetated mats according to an embodiment of the present application.

FIG. 3 shows exemplary images providing a comparison of meadow seed mixture germination and growth when an additional layer of PET is placed over a carrier mat comprising PET (FIG. 3A), and without (FIG. 3B), demonstrating the weed suppressive nature and/or selective facilitation of grass growth from underlying seeds possible with carrier mats comprised of PET.

FIG. 4 shows exemplary images providing a comparison between the algae growth on pre-vegetated mats produced using commercially available seed carrier mixtures (A-Flexterra™ and B-Fibramulch™) and with a seed carrier mixture (C) developed in the studies of the present application which contains no wood or paper fiber materials (Table 2, Mix 6). Significant algae growth is observed on the pre-vegetated mats shown in FIGS. 4A and 4B whereas the soilless pre-vegetated mat produced using the seed carrier mixture developed in the studies of the present application is observed to have minimal algae growth (FIG. 4C).

### DETAILED DESCRIPTION OF THE APPLICATION

### I. Definitions

Unless otherwise indicated, the definitions and embodiments described in this and other sections are intended to be applicable to all embodiments and aspects of the application herein described for which they are suitable as would be understood by a person skilled in the art.

As used in this application, the singular forms “a”, “an” and “the” include plural references unless the content clearly dictates otherwise. For example, an embodiment including “a fiber” should be understood to present certain aspects with one fiber, or two or more additional fibers.

In embodiments comprising an “additional” or “second” component, such as an additional or second fiber, the second component as used herein is different from the other components or first component. A “third” component is different from the other, first, and second components, and further enumerated or “additional” components are similarly different.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The term “exterior growing conditions” as used herein refers to any outdoor environment in any location in the world, and its corresponding temperature, precipitation, wind amount and light amount, to which any plant growing in that environment, is exposed.

The term “does not degrade under exterior growing conditions” means that the referred-to material does not break down or degrade for a time period sufficient for the soilless pre-vegetated mat to serve its intended purpose. Examples of such time periods include from about 1 day to about 50 years, about 60 days to about 20 years, about 6 months to about 10 years or about 1 year to about 5 years. By “degrade” or “break down” it is meant that the carrier mat's integrity is reduced to an extent where it no longer performs its intended purpose or function, for example, weed suppression and/or structural support.

The term “vegetation propagation material” as used herein refers to portions of a plant which, when used in the processes of the present application, result in the production of the desired vegetation on and/or within the soilless pre-vegetated mats. For example, Sedum sp. can be produced from either cuttings or seed as the vegetation propagation material using the processes of the present application. Typically Sedum vegetation is produced from cuttings, as it is known, for example to grow slowly from seed. Other species of vegetation, for example herbaceous plants can also be produced from cuttings. Cuttings from herbaceous plants typically need to be nursed, with a lot of attention and time dedicated to maintaining the optimal conditions for root formation, for example. It is useful to use seeds as the vegetation propagation material to produce herbaceous plants because herbaceous plants, for example are known to rapidly grow from seed. Several examples of vegetation that were grown using the processes of the present application using vegetation seeds and/or cuttings as the vegetation propagation material are provided in Tables 1 and 3-9 and are further described in the text of the Examples. The soilless pre-vegetated mats of the present application can be produced using a customized mixture of vegetation propagation material for a particular purchaser. The selection of a suitable vegetation propagation material, for example, vegetation seeds and/or vegetation cuttings for the desired vegetation can be made by a person skilled in the art.

The term “meadow seed mixture” as used herein refers to a mixture comprising, consisting essentially of or consisting of Bachelor Buttons (Centaurea cyanus) seeds, Black Eyed Susan (Rudbecki hirta) seeds, California Poppy (Eschscholtzia rhoes) seeds, Evening Scented Primrose (Oenothera biennis) seeds, Hard Fescue (Festuca longifolia) seeds, Lance Leaf Coreopsis (Coreopsis lanceolata) seeds, Scarlet Flax (Linum grandiflorum) seeds, Sheep's Fescue (Festuca ovina) seeds, Wild Lupine (Lupine perennis) seeds and Yellow Prairie Coneflower (Ratibida columnifera) seeds. In the processes of the present application, the meadow seed mixture can be used, for example, to produce a soilless pre-vegetated mat wherein the vegetation comprises, consists essentially of or consists of meadow vegetation. The meadow vegetation may comprise, consist essentially of or consist of Bachelor Buttons (Centaurea cyanus), Black Eyed Susan (Rudbecki hirta), California Poppy (Eschscholtzia rhoes), Evening Scented Primrose (Oenothera biennis), Hard Fescue (Festuca longifolia), Lance Leaf Coreopsis (Coreopsis lanceolata), Scarlet Flax (Linum grandiflorum), Sheep's Fescue (Festuca ovina), Wild Lupine (Lupine perennis) and Yellow Prairie Coneflower (Ratibida columnifera).

The term “drought tolerant seed mixture” as used herein refers to a mixture either comprising, consisting essentially of or consisting of Black Eyed Susan (Rudbecka hirta) seeds, Buffalo Grass (Buchloe dactyloides) seeds, Common Milkweed (Asclepias syriaca) seeds, Evening Scented Primrose (Oenothera biennis) seeds, Hoary Vervain (Verbena stricta) seeds, Lance Leaf Coreopsis (Coreopsis lanceolata) seeds, Sand Dropseed (Sporobolus cryptandra) seeds, Ticklegrass (Agrostis scabra) seeds, White Yarrow (Achillea millifolium) seeds and Dwarf Plains Coreopsis (Coreopsis tinctoria) seeds or comprising, consisting essentially of or consisting of Black Eyed Susan (Rudbecka hirta) seeds, California Poppy (Eschscholtzia rhoes) seeds, Bachelor Buttons (Centaurea cyanus) seeds, Lance Leaf Coreopsis (Coreopsis lanceolata) seeds, Dwarf Plains Coreopsis (Coreopsis tinctoria) seeds, Wild Lupine (Lupine perennis) seeds, Yellow Prairie Coneflower (Ratibida columnifera) seeds, Rocky Mountain Penstemon (Penstemon strictus) seeds, Canada Wild Rye (Elymus Canadensis) seeds, Little Bluestem (Schizachyrium scoparium) seeds and Alpine Aster (Aster alpines) seeds. In the processes of the present application, the drought tolerant seed mixture can be used, for example, to produce a soilless pre-vegetated mat wherein the vegetation comprises, consists essentially of or consists of drought tolerant vegetation. The drought tolerant vegetation may either comprise, consist essentially of or consist of Black Eyed Susan (Rudbecka hirta), Buffalo Grass (Buchloe dactyloides), Common Milkweed (Asclepias syriaca), Evening Scented Primrose (Oenothera biennis), Hoary Vervain (Verbena stricta), Lance Leaf Coreopsis (Coreopsis lanceolata), Sand Dropseed (Sporobolus cryptandra), Ticklegrass (Agrostis scabra), White Yarrow (Achillea millifolium) and Dwarf Plains Coreopsis (Coreopsis tinctoria) or comprise, consist essentially of or consist of Black Eyed Susan (Rudbecka hirta), California Poppy (Eschscholtzia rhoes), Bachelor Buttons (Centaurea cyanus), Lance Leaf Coreopsis (Coreopsis lanceolata), Dwarf Plains Coreopsis (Coreopsis tinctoria), Wild Lupine (Lupine perennis), Yellow Prairie Coneflower (Ratibida columnifera), Rocky Mountain Penstemon (Penstemon strictus), Canada Wild Rye (Elymus Canadensis), Little Bluestem (Schizachyrium scoparium) and Alpine Aster (Aster alpines).

The term “xeri-scaping seed mixture” as used herein refers, for example, to a drought tolerant seed mixture comprising, consisting essentially of or consisting of Black Eyed Susan (Rudbecka hirta) seeds, Buffalo Grass (Buchloe dactyloides) seeds, Common Milkweed (Asclepias syriaca) seeds, Evening Scented Primrose (Oenothera biennis) seeds, Hoary Vervain (Verbena stricta) seeds, Lance Leaf Coreopsis (Coreopsis lanceolata) seeds, Sand Dropseed (Sporobolus cryptandra) seeds, Ticklegrass (Agrostis scabra) seeds, White Yarrow (Achillea millifolium) seeds and Dwarf Plains Coreopsis (Coreopsis tinctoria) seeds. In the processes of the present application, the xeri-scaping seed mixture can be used, for example, to produce a soilless pre-vegetated mat wherein the vegetation comprises, consists essentially of or consists of xeri-scaping vegetation. The xeri-scaping vegetation may comprise, consist essentially of or consist of Black Eyed Susan (Rudbecka hirta), Buffalo Grass (Buchloe dactyloides), Common Milkweed (Asclepias syriaca), Evening Scented Primrose (Oenothera biennis), Hoary Vervain (Verbena stricta), Lance Leaf Coreopsis (Coreopsis lanceolata), Sand Dropseed (Sporobolus cryptandra), Ticklegrass (Agrostis scabra), White Yarrow (Achillea millifolium) and Dwarf Plains Coreopsis (Coreopsis tinctoria).

The term “Sedum mixture” as used herein refers to, for example, a mixture comprising, consisting essentially of or consisting of two or more Sedum species. There exists a large variety of Sedum species that would be expected to work in the soilless pre-vegetated mats and processes of the present application. New cultivars are also expected to be created that would be expected to work in the soilless pre-vegetated mats and processes of the present application. A person skilled in the art would appreciate that, for example, some Sedum species are easy to grow, and some are harder to grow. The selection of a suitable Sedum species will depend, for example, on the depth of the substrate upon which the soilless pre-vegetated mat is to be placed; i.e. some Sedum species are suited to shallow substrates whereas some are suited to deeper substrates. The selection of suitable Sedum species for inclusion in a Sedum mixture can be made by a person skilled in the art.

It is an embodiment that the Sedum mixture comprises, consists essentially of or consists of two or more of Sedum album cuttings and/or seeds, Sedum spurium (Royal Pink, Schorbusser Blut, Fuldaglut, Dragons Blood) cuttings and/or seeds, Sedum kamtschaticum cuttings and/or seeds, Sedum reflexum cuttings and/or seeds, Sedum sexangulare cuttings and/or seeds and Sedum hybridum cuttings and/or seeds. In an embodiment, the Sedum mixture comprises, consists essentially of or consists of Sedum album cuttings and/or seeds and Sedum spurium (Royal Pink, Schorbusser Blut, Fuldaglut, Dragons Blood) cuttings and/or seeds. In another embodiment, the Sedum mixture comprises, consists essentially of or consists of Sedum kamtschaticum cuttings and/or seeds, Sedum reflexum cuttings and/or seeds, Sedum sexangulare cuttings and/or seeds and Sedum hybridum cuttings and/or seeds. In the processes of the present application, the Sedum mixture can be used, for example, to produce a soilless pre-vegetated mat wherein the vegetation comprises, consists essentially of or consists of Sedum vegetation. Accordingly, the Sedum vegetation may comprise, consist essentially of or consist of two or more Sedum species. In an embodiment, the Sedum vegetation comprises, consists essentially of or consists of two or more of Sedum album, Sedum spurium, Sedum kamtschaticum, Sedum reflexum, Sedum sexangulare and Sedum hybridum. In another embodiment, the Sedum vegetation comprises, consists essentially of or consists of Sedum album and Sedum spurium. In an embodiment, the Sedum vegetation comprises, consists essentially of or consists of Sedum kamtschaticum, Sedum reflexum, Sedum sexangulare and Sedum hybridum.

The term “grass” as used herein includes all grasses commonly used within the lawning and landscaping industry. The selection of a suitable grass can be made by a person skilled in the art. The term “grass” as used herein includes members of the family Poaceae or Gramineae (common grasses) and includes, for example Blue Grama (Bouteloua gracilis), Little Bluestem (Schizachyrium scoparium), Canada Wild Rye (Elymus canadensis), Buffalo Grass (Buchloe dactyloides) and Hard Fescue (Festuca longifolia). In the processes of the present application, a selection of one or more of Blue Grama (Bouteloua gracilis) seeds, Little Bluestem (Schizachyrium scoparium) seeds, Canada Wild Rye (Elymus canadensis) seeds, Buffalo Grass (Buchloe dactyloides) seeds and Hard Fescue (Festuca longifolia) seeds may be used to produce soilless pre-vegetated mats wherein the vegetation comprises, consists essentially of or consists of one or more of Blue Grama (Bouteloua gracilis), Little Bluestem (Schizachyrium scoparium), Canada Wild Rye (Elymus canadensis), Buffalo Grass (Buchloe dactyloides) and Hard Fescue (Festuca longifolia).

The term “herbaceous plant” as used herein refers, for example to any annual, perennial or biennial plant that possesses leaves and a stem, and whose above-ground tissue dies back at the end of a growing season, for example, grass, wildflowers, ornamental perennials, vegetables and herbs.

The term “soilless” as used herein refers to a pre-vegetated mat that is substantially free of soil. The expression “substantially free of soil” as used herein means that the pre-vegetated mat does not comprise soil or a similar material in amounts that would be useful as a growth medium but may comprise small amounts, for example less than about 5, 4, 3, 2, 1, 0.5 or 0.1% of the total weight of the pre-vegetated mat of soil or a similar material which was transferred to the pre-vegetated mat at some point during the processes of the application. The soilless pre-vegetated mats of the present application may contain small amounts of less than about 10, 9, 8, 7, 6, 5, 4, 3, 2, 1, 0.5 or 0.1% by weight of the total weight of the soilless pre-vegetated mat of, for example, vegetation propagation material that did not grow into vegetation as well as other components of the carrier mixture, for example.

The term “hydroponic growing conditions” as used herein refers to any conditions for growing plants using mineral nutrient solutions, in water, without soil. Such conditions may vary, for example, in the type of solution culture, irrigation techniques, reservoirs or containers and/or nutrient solutions used. For example, the solution culture comprises static solution cultures, or continuous—flow solution cultures or aeroponics (use of fine mist or aerosols). In embodiments of the application, irrigation techniques comprise sub-irrigation or top irrigation techniques. In further embodiments, reservoirs or containers are made of any suitable material, such as concrete, plastic, glass, metal, vegetable solids and/or wood. In an embodiment, the containers exclude light to prevent algae growth in the nutrient medium. Such techniques and methods are known to a person skilled in the art. An example of hydroponic growing conditions useful in the processes of the present application is Nutrient Film Technology (NFT). NFT is a hydroponic growing technique wherein a very shallow stream of water containing dissolved nutrients (water-based nutrient solution or water-based fertilizer solution) required for plant growth is recirculated past the roots of plants in a water-tight gully, also known as channels. The depth of the recirculating stream is typically no more than a film of water.

The term “water-based nutrient solution” or “water-based fertilizer solution” and the like as used herein refers to an aqueous solution comprising a source of nitrogen, a source of phosphorous, a source of potassium, and trace amounts of sources of one or more micronutrients. It is an embodiment that the sources of the one or more micronutrients are selected from the group consisting of boron, calcium, chlorine, copper, iron, magnesium, manganese, molybdenum, nickel, silicon, selenium, sodium, sulfur and zinc.

PET as used herein refers to polyethylene terephthalate, which is a polymer comprising the following monomeric unit:

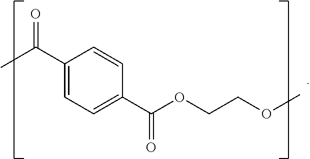

EPDM as used herein refers to ethylene propylene diene monomer (M-class) rubber.

The term “modified Hoagland's fertilizer solution” or “modified Hoagland's solution” or “modified Hoagland's” or the like as used herein refers, for example, to a water-based solution of nutrients used for growing plants under hydroponic growing conditions. A number of modified Hoagland's solutions are known in the art, and the choice of a suitable Hoagland's solution for a particular soilless pre-vegetated mat or process for production thereof can be made by a person skilled in the art, for example with reference to Epstein E., Mineral Nutrition of Plants: Principles and Perspectives. London: John Wiley & Sons; 1972. In an embodiment, the modified Hoagland's solution is an aqueous solution comprising a source of phosphorous at a phosphorous concentration of about 2 mmol/L or about 61.940 ppm; a source of calcium at a calcium concentration of about 4 mmol/L or about 160.312 ppm; a source of nitrogen in the form of NH₄⁺ at a NH₄⁺ concentration of about 2 mmol/L or about 28.000 ppm; a source of nitrogen in the form of NO₃⁻ at an NO⁻ concentration of about 14 mmol/L or about 196.000 ppm; a source of potassium at a potassium concentration of about 6 mmol/L or about 234.588 ppm; a source of sulfur at a sulfur concentration of about 2 ppm or about 64.132 ppm; a source of magnesium at a magnesium concentration of about 2 mmol/L or about 48.610 ppm; a source of manganese at a manganese concentration of about 0.0091 mmol/L or about 0.500 ppm; a source of iron at an iron concentration of about 0.05 mmol/L or about 2.792 ppm; a source of zinc at a zinc concentration of about 0.0008 mmol/L or about 0.052 ppm; a source of boron at a boron concentration of about 0.0182 mmol/L or about 0.197 ppm; a source of copper at a copper concentration of about 0.0008 ppm or about 0.051 ppm; and a source of molybdenum at a molybdenum concentration of about 0.0005 mmol/L or about 0.048 ppm.

### II. Processes of the Application

In the present application, processes for the production of soilless pre-vegetated mats have been developed. In certain embodiment, the processes use, for example, a farm-based growing apparatus to produce the soilless pre-vegetated mats of the present application. The developed processes are used in, for example, controlled environment growing systems or outside on graded land, with the below-described subtle differences in methodology and execution.

A number of benefits of the processes of the present application have been demonstrated and/or are expected over other known processes for producing green roof mat systems and/or mat systems for other purposes.

For example, the processes of the present application produce soilless pre-vegetated mats that show weed suppression resulting from the use of a carrier mat that does not degrade under exterior growing conditions, such as polyethylene terephthalate (PET). Because the soilless pre-vegetated mats of the present application have a carrier mat comprised of a material that does not degrade under exterior growing conditions, weed suppression is expected to be long-term. For example, weed suppression is expected to last longer than that expected for pre-vegetated mats comprising a carrier mat that does degrade under exterior growing conditions. Tests conducted for the studies of the present application have indicated that weeds, or weed seeds existing in the substrate which the mat is placed over, cannot penetrate the PET or similar mat that does not degrade under exterior growing conditions due to their fine weave. Grass however, can still penetrate.

Further, the processes of the present application have been demonstrated to have comparatively rapid production times. The processes of the present application produce harvested materials in about a 1 month time period whereas known production systems take approximately 3-4 months. For example, Sedum mats and herbaceous perennial/annual plant mats were produced in about a 1 month time period using the processes of the present application. It has also been demonstrated that Sedum mats are produced in this timeframe using significantly less starting material (for example, cuttings) than existing systems. While orders for existing systems typically occur about one year in advance, the processes of the present application only require about a 1-2 month lead time.

The processes of the present application have also been demonstrated to result in significant water and nutrient-use reductions during production over known systems. Like other Nutrient Film Technology (NFT) growing systems, the processes of the present application use about 1/10 of the water and nutrients used during other known pre-vegetated mat production processes.

Further, the processes of the present application allow for flexibility in the location for production of the corresponding soilless pre-vegetated mats. It is expected that only limited modification to existing greenhouse structures would be necessary, and low capital costs for outdoor system establishment are predicted.

Still even further, the processes of the present application have been demonstrated to be flexible in terms of both vegetation species, and vegetation species combinations. It is predicted that virtually any suitable vegetation or vegetation combination can be grown using the processes of the present application, with minimal modification to the parameters used.

The processes of the present application are also expected to have a significantly reduced cost of production. Typical mats produced for green roofs are known to cost (in 2012) roughly $60,000/acre to produce and retail at about $4/ft² for the standard, and about $7/ft² for the “light weight” version, which is still far heavier than the soilless pre-vegetated mats developed by the processes of the present application. Much of this cost comes from the expensive geotextile base which is used (about $30,000/acre in 2012) and from the extensive labour requirements of production. Estimates for the soilless pre-vegetated mats produced by the processes of the present application are about $10,000-$20,000/acre (2012, Canadian dollars).

Production of the soilless pre-vegetated mats using the processes of the present application does not result in any detectable damage to the roots or restrict their growth, facilitating rapid root penetration and anchorage into the substrate layer. In contrast, typical mat supporting layers for currently known green roofs have a geotextile backing layer which restricts root growth when placed on soil. Traditional methods for cutting sod mechanically cut the roots, which severely delays establishment when laid on a substrate.

Accordingly, the present application includes a process for producing a pre-vegetated mat, comprising:
depositing a carrier mixture comprising vegetation propagation material suspended in an aqueous solution comprising a tackifying agent and a water-absorbing polymer on a carrier mat that does not degrade under exterior growing conditions; and
subjecting the carrier mixture on the carrier mat to hydroponic growing conditions,
wherein the pre-vegetated mat is soilless.

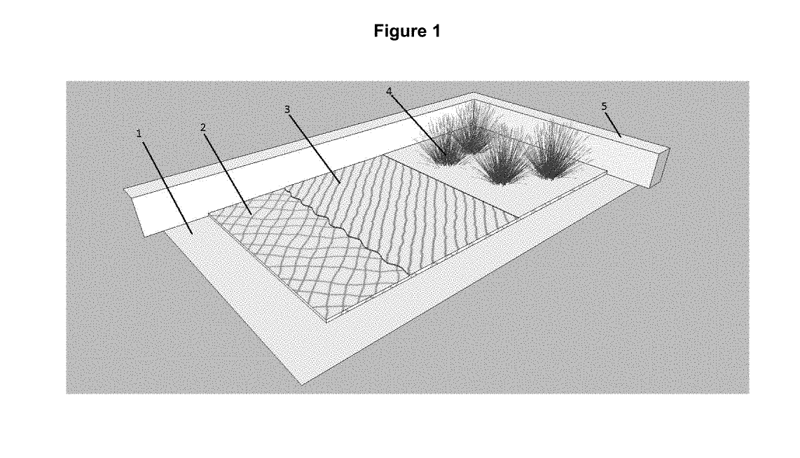

As shown in FIG. 1, there is a large variability in plant species 4 which can be grown using the processes of the present application. Species grown for green roof applications including, for example, Sedum sp., have been shown to be propagated quickly using the processes of the present application through the application of cuttings, as were an assortment of other herbaceous plants through the application of seed. Grass sod can be produced in the processes of the present application which is lightweight and soil free.

Soilless pre-vegetated mats comprising species suitable for erosion control can also be easily prepared using the processes of the present application. There is a diverse array of vegetation used for erosion control and the selection of suitable vegetation for a particular use can be made by a person skilled in the art. For example, when used on a side of a road, grasses and Crown Vetch (Securigera varia) are commonly selected vegetation for erosion control. Accordingly, in an embodiment, the vegetation suitable for erosion control is selected from grasses and Crown Vetch (Securigera varia). Perennials are another example of vegetation for erosion control as they can, for example, return year after year to provide the same erosion protection. Accordingly, in another embodiment, the vegetation suitable for erosion control is one or more perennials. Sometimes greater diversity is desired, as is the use of indigenous species. Accordingly, in an embodiment, the vegetation suitable for erosion control further includes indigenous species. While vegetation was formerly typically selected which could quickly colonize the land to be stabilized, the soilless pre-vegetated mats of the present application are pre-grown so colonizing is already achieved, and full root establishment can occur very soon after. Accordingly, the need for the vegetation to quickly colonize the land is not as important a criteria for the selection of a vegetation suitable for erosion control in the soilless pre-vegetated mats of the present application and processes for production thereof.

As shown in FIG. 1, in an embodiment of the present application, a carrier mixture 3 is deposited on a carrier mat 2 using, for example, a hydro-seeding apparatus. The carrier mixture 3 is a mixture of vegetation propagation material that is suspended in an aqueous solution comprising a tackifying agent, a water-absorbing polymer, for example, a polyacrylamide polymer and optionally, a water-soluble fertilizer and additional synthetic fibers or natural fibers. For example, the synthetic fibers can comprise the same material the carrier mat 2 is comprised of, for example polyethylene terephthalate or a similar material. Such fibers can, for example, provide additional anchoring to the carrier mat 2 of the vegetation propagation material and the tackifying agent. Natural fibers can, for example, include coir, hemp, jute and flax. The inclusion of fibers in the carrier mixture 3 is useful where the soilless pre-vegetated mat will be grown, for example in a production scenario with a higher than recommended slope. For example, the inclusion of fibers is useful if a soilless pre-vegetated mat is being produced on a slope greater than about 5 degrees. The inclusion of fibers is not expected to have an effect on a fully-grown soilless pre-vegetated mat's ability to suppress erosion on the slope for which it was placed to prevent erosion on.

In an embodiment, the tackifying agent, water-absorbing polymer, vegetation propagation material, and optionally the water-soluble fertilizer and/or fibers are mixed with water into a uniform consistency, and the resulting carrier mixture 3 sprayed evenly over the carrier mat 2. A matrix of tackifying agent, water-absorbing polymer, vegetation propagation material, and optionally water-soluble fertilizer and/or fibers forms, providing excellent conditions for seed germination. Soon after the seeds germinate, it was demonstrated that the roots of the vegetation intertwine within and under the carrier mat 2 to form a mat of roots which, for example supports plant growth and prevents erosion from rain and/or irrigation. After installation, this mat of roots has been demonstrated to quickly anchor into soil or other growing substrates to support plant growth and prevent soil erosion from both wind and rain.

In an embodiment, the vegetation propagation material is deposited between at least two layers of the carrier mat. For example, the vegetation propagation material is deposited on to one layer of the carrier mat and a second layer of carrier mat is placed on top of the first carrier mat with the vegetation propagation material deposited thereon. The layered carrier mat arrangement is then subjected to hydroponic growing conditions. In this embodiment, weed suppression is enhanced in particular for grasses, as the grasses preferentially can grow through the top carrier mat.

In an embodiment, the vegetation propagation material is vegetation seeds and/or vegetation cuttings. In another embodiment of the present application, the vegetation propagation material is vegetation seeds. In another embodiment, the vegetation propagation material is vegetation cuttings.

In an embodiment, the vegetation propagation material is vegetation seeds and vegetation cuttings. In another embodiment, the vegetation propagation material is vegetation seeds and vegetation cuttings, wherein the vegetation seeds are seeds from a xeri-scaping seed mixture and the vegetation cuttings are cuttings from a Sedum mixture.

In an embodiment, the vegetation seeds are seeds from a meadow seed mixture, a drought tolerant seed mixture, a Sedum mixture or grass seeds. In another embodiment, the vegetation seeds are seeds from one or more of a meadow seed mixture, a drought tolerant seed mixture, a Sedum mixture and grass seeds. In a further embodiment, the vegetation seeds are seeds from a meadow seed mixture and a drought tolerant seed mixture. It is an embodiment that the drought tolerant seed mixture is a xeri-scaping seed mixture.

It is an embodiment that the meadow seed mixture comprises, consists essentially of or consists of Bachelor Buttons (Centaurea cyanus) seeds, Black Eyed Susan (Rudbecki hirta) seeds, California Poppy (Eschscholtzia rhoes) seeds, Evening Scented Primrose (Oenothera biennis) seeds, Hard Fescue (Festuca longifolia) seeds, Lance Leaf Coreopsis (Coreopsis lanceolata) seeds, Scarlet Flax (Linum grandiflorum) seeds, Sheep's Fescue (Festuca ovina) seeds, Wild Lupine (Lupine perennis) seeds and Yellow Prairie Coneflower (Ratibida columnifera) seeds.

It is another embodiment that the drought tolerant seed mixture comprises, consists essentially of or consists of Black Eyed Susan (Rudbecka hirta) seeds, Buffalo Grass (Buchloe dactyloides) seeds, Common Milkweed (Asclepias syriaca) seeds, Evening Scented Primrose (Oenothera biennis) seeds, Hoary Vervain (Verbena stricta) seeds, Lance Leaf Coreopsis (Coreopsis lanceolata) seeds, Sand Dropseed (Sporobolus cryptandra) seeds, Ticklegrass (Agrostis scabra) seeds, White Yarrow (Achillea millifolium) seeds and Dwarf Plains Coreopsis (Coreopsis tinctoria) seeds. In an embodiment, the drought tolerant seed mixture comprises, consists essentially of or consists of Black Eyed Susan (Rudbecka hirta) seeds, California Poppy (Eschscholtzia rhoes) seeds, Bachelor Buttons (Centaurea cyanus) seeds, Lance Leaf Coreopsis (Coreopsis lanceolata) seeds, Dwarf Plains Coreopsis (Coreopsis tinctoria) seeds, Wild Lupine (Lupine perennis) seeds, Yellow Prairie Coneflower (Ratibida columnifera) seeds, Rocky Mountain Penstemon (Penstemon strictus) seeds, Canada Wild Rye (Elymus Canadensis) seeds, Little Bluestem (Schizachyrium scoparium) seeds and Alpine Aster (Aster alpines) seeds.

It is an embodiment that the Sedum mixture comprises, consists essentially of or consists of Sedum album seeds, Sedum spurium (Royal Pink, Schorbusser Blut, Fuldaglut, Dragons Blood) seeds, Sedum kamtschaticum seeds, Sedum reflexum seeds, Sedum sexangulare seeds and Sedum hybridum seeds. In a further embodiment, the Sedum mixture comprises, consists essentially of or consists of Sedum album seeds and Sedum spurium (Royal Pink, Schorbusser Blut, Fuldaglut, Dragons Blood) seeds. In another embodiment, the Sedum mixture comprises, consists essentially of or consists of Sedum kamtschaticum seeds, Sedum reflexum seeds, Sedum sexangulare seeds and Sedum hybridum seeds.

In another embodiment of the present application, the grass seeds are selected from one or more of Blue Grama (Bouteloua gracilis) seeds, Little Bluestem (Schizachyrium scoparium) seeds, Canada Wild Rye (Elymus canadensis) seeds, Buffalo Grass (Buchloe dactyloides) seeds and Hard Fescue (Festuca longifolia) seeds.

In an embodiment, the vegetation seeds are seeds from one or more herbaceous plants. It is an embodiment that the one or more herbaceous plants are selected from grass, wildflowers, ornamental perennials, vegetables and herbs. In another embodiment, the one or more herbaceous plants are selected from grass and wildflowers.

In an embodiment, the vegetation cuttings are cuttings from a Sedum species or a Sedum mixture. In an embodiment, the Sedum species is selected from Sedum album, Sedum spurium, Sedum kamtschaticum, Sedum reflexum, Sedum sexangulare and Sedum hybridum. A person skilled in the art would understand that there are other Sedum species which can be used. In another embodiment, the Sedum mixture comprises, consists essentially of or consists of two or more of Sedum album cuttings, Sedum spurium (Royal Pink, Schorbusser Blut, Fuldaglut, Dragons Blood) cuttings, Sedum kamtschaticum cuttings, Sedum reflexum cuttings, Sedum sexangulare cuttings and Sedum hybridum cuttings. In a further embodiment, the Sedum mixture comprises, consists essentially of or consists of Sedum album cuttings and Sedum spurium (Royal Pink, Schorbusser Blut, Fuldaglut, Dragons Blood) cuttings. It is an embodiment that the Sedum mixture comprises, consists essentially of or consists of Sedum kamtschaticum cuttings, Sedum reflexum cuttings, Sedum sexangulare cuttings and Sedum hybridum cuttings.

It was observed in the present studies that vegetation mixtures having higher concentrations of Buffalo Grass (Buchloe dactyloides) and/or White Yarrow (Achillea millifolium), for example, vegetation produced from seed mixtures having above about 5 wt % or about 10 wt % of the total mass of seeds therein of Buffalo Grass (Buchloe dactyloides) and/or above about 5 wt % or about 10 wt % of the total mass of seeds therein of White Yarrow (Achillea millifolium), the Buffalo Grass (Buchloe dactyloides) and/or White Yarrow (Achillea millifolium) tended to reduce the population numbers of the other species present as, for example these species were so prolific. Accordingly, in an embodiment, the vegetation propagation material comprises, consists essentially of or consists of less than about 10 wt % of the total mass of seeds therein of Buffalo Grass (Buchloe dactyloides) seeds. In another embodiment, the vegetation propagation material comprises, consists essentially of or consists of less than about 5 wt % of the total mass of seeds therein of Buffalo Grass (Buchloe dactyloides) seeds. In an embodiment, the vegetation propagation material comprises, consists essentially of or consists of less than about 10 wt % of the total mass of seeds therein of White Yarrow (Achillea millifolium) seeds. In another embodiment, the vegetation propagation material comprises, consists essentially of or consists of less than about 5 wt % of the total mass of seeds therein of White Yarrow (Achillea millifolium) seeds. In a further embodiment, the vegetation propagation material comprises, consists essentially of or consists of less than about 10 wt % of the total mass of seeds therein of Buffalo Grass (Buchloe dactyloides) seeds and less than about 10 wt % of the total mass of seeds therein of White Yarrow (Achillea millifolium) seeds. It is an embodiment that the vegetation propagation material comprises, consists essentially of or consists of less than about 5 wt % of the total mass of seeds therein of Buffalo Grass (Buchloe dactyloides) seeds and less than about 5 wt % of the total mass of seeds therein of White Yarrow (Achillea millifolium) seeds.

The vegetation grown from combination 2 set out in Table 8 was observed to be particularly esthetically appealing. Accordingly, in an embodiment, the vegetation propagation material comprises, consists essentially of or consists of about 5 wt % Black Eyed Susan (Rudbecki hirta) seeds, about 5 wt % Bachelor Buttons (Centaurea cyanus) seeds, about 5 wt % California Poppy (Eschscholtzia rhoes) seeds, about 10 wt % Scarlet Flax (Linum grandiflorum) seeds, about 10 wt % Lance Leaf Coreopsis (Coreopsis lanceolata) seeds, about 10 wt % Dwarf Plains Coreopsis (Coreopsis tinctoria) seeds, about 10 wt % Wild Lupine (Lupine perennis) seeds, about 20 wt % Rocky Mountain Penstemon (Penstemon strictus) seeds, about 5 wt % Canada Wild Rye (Elymus canadensis) seeds, about 15 wt % Little Bluestem (Schizachyrium scoparium) seeds and about 5 wt % Alpine Aster (Aster alpines) seeds.

In an embodiment, the water-soluble fertilizer comprises a source of nitrogen, a source of phosphorous, a source of potassium, and trace amounts of sources of one or more micronutrients. It is an embodiment that the sources of the one or more micronutrients are selected from boron, calcium, chlorine, copper, iron, magnesium, manganese, molybdenum, nickel, silicon, selenium, sodium, sulfur and zinc. In another embodiment, the water-soluble fertilizer comprises all essential plant nutrients and accordingly is a plant nutrient medium. In a further embodiment, the water-soluble fertilizer comprises a source of nitrogen, a source of phosphorous, a source of potassium, a source of boron, a source of calcium, a source of chlorine, a source of copper, a source of iron, a source of magnesium, a source of manganese, a source of molybdenum, a source of nickel, a source of silicon, a source of selenium, a source of sodium, a source of sulfur and a source of zinc. The exact formulation of the water-soluble fertilizer, for example the ingredient concentrations depends, for example, on the vegetation being grown, the season the vegetation is being grown in, and the speed with which it is desired to grow the vegetation and the selection of a suitable water-soluble fertilizer can be made by a person skilled in the art. The water-soluble fertilizer may be obtained from a commercial source or it may be a customized water-soluble fertilizer. For example, the water-soluble fertilizer is a Hoagland's solution or a modified Hoagland's solution. In a further embodiment, the water-soluble fertilizer is a 20N-8P-20K water-soluble fertilizer or a 20N-4P-16K water-soluble fertilizer, optionally having trace amounts of sources of one or more micronutrients.

In an embodiment, the tackifying agent is, for example, an organic glue, for example, a glue comprising guar gum or a glue made from the plantago (Plantago ovata) plant, such as a glue made from the protective coating of the plantago seed, or a mixture thereof. In another embodiment, the tackifying agent is a polyacrylamide, for example a polyacrylamide having a fine particle size, i.e. a particle size of less than about 0.3 mm. The tackifying agent may be obtained from a commercial source. The choice of a suitable tackifying agent for a particular soilless pre-vegetated mat and/or use of the soilless pre-vegetated mat can be made by a person skilled in the art.

In an embodiment of the present application, the water-absorbing polymer is, for example, a polyacrylamide, for example, a polyacrylamide having a small particle size; i.e. a particle size ranging from about 0.3 mm to about 2 mm or about 1 mm. Polyacrylamide polymers having a small particle size may, for example, absorb and release water therefore reducing the amount of water used in irrigation significantly. An advantage of a polyacrylamide is that it may have a capacity to store and release water for a period of up to about seven years.

In an embodiment, the tackifying agent and the water-absorbing polymer both comprise polyacrylamide. It is an embodiment that the tackifying agent comprises a polyacrylamide having a fine particle size and the water-absorbing polymer comprises a polyacrylamide having a small particle size.

It is an embodiment that the carrier mixture further comprises one or more types of fibers. In an embodiment, the one or more types of fibers are selected from synthetic fibers and natural fibers. In another embodiment, the fibers are synthetic fibers. In a further embodiment, the synthetic fibers are fibers comprised of a film-forming thermoplastic polymer that does not degrade under exterior growing conditions. It is an embodiment that the synthetic fibers are selected from the group consisting of polyethylene terephthalate fibers, fibers of other polyesters that do not degrade under exterior growing conditions, polyethylene fibers, polypropylene fibers, polyvinylchloride fibers and nylon fibers. It is an embodiment of the present application that the synthetic fibers are polyethylene terephthalate fibers. In another embodiment, the fibers are natural fibers. It is an embodiment that the natural fibers are selected from the group consisting of coir fibers, hemp fibers, jute fibers and flax fibers.

As shown in FIG. 1, it is an embodiment of the present application that the vegetation 4 is grown on a carrier mat 2. In a further embodiment, the carrier mat 2 is placed on a waterproof membrane 1 in an orderly fashion, in manageable sizes, to facilitate easy harvesting. After the carrier mat 2 is placed, the carrier mat 2 is populated with plant vegetation material, dispersed over the carrier mat 2 via a carrier mixture 3 as described above.

The carrier mat 2 shown in FIG. 1 does not degrade under exterior growing conditions. Polyethylene terephthalate and similar materials are examples of a material that does not degrade under exterior growing conditions. Accordingly, in an embodiment, the carrier mat is comprised of polyethylene terephthalate or a similar material, for example other types of film-forming thermoplastic polyesters that do not degrade under exterior growing conditions, or other types of film-forming thermoplastic polymers such as polyethylene, polypropylene, polyvinylchloride (PVC) and nylon, or a nylon/polymer composite material, for example like that used in the WaterWay™ mats which are reported to comprise a nylon/polymer core of fused, entangled filaments. Other commercial sources of carrier mats comprised of a nylon-polymer composite material are known, and are available with, for example, different densities and strand thicknesses. It is an embodiment that the carrier mat is comprised of polyethylene terephthalate. It is an embodiment that the polyethylene terephthalate or similar material is woven or unwoven. In another embodiment, the polyethylene terephthalate comprising the carrier mat is woven. The material used is based, for example on the intended application and/or the availability of the material, and the selection of a suitable carrier mat material is within the capability of one skilled in the art.

In an embodiment, the processes of the present application comprise subjecting the carrier mixture 3 on the carrier mat 2 to hydroponic growing conditions. For example, it has been shown that a large Nutrient Film Technology (NFT) system as described herein can be used to supply the hydroponic growing conditions.

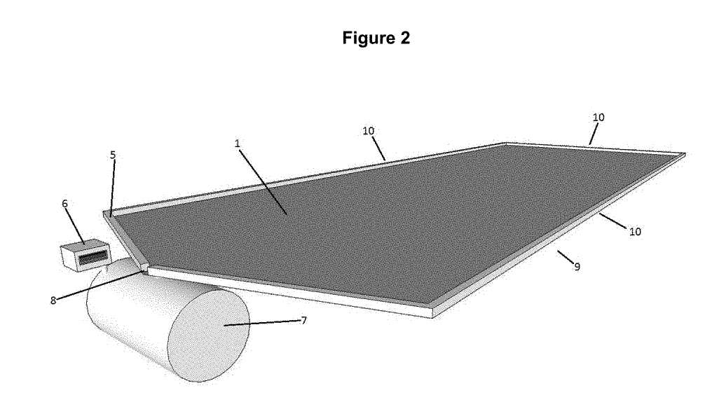

As shown in FIGS. 1 and 2, in one embodiment of the application, about an one acre outdoor production system is comprised of graded land, a waterproof membrane with confining edging 1 or alternatively a concrete surface, an irrigation area 10, a nutrient and water reservoir 7, and an irrigation control and pump 6. The production area is sloped 9 towards the nutrient and water reservoir 7 and irrigation control and pumping station 6.

Accordingly, it is an embodiment of the present application that the hydroponic growing conditions comprise:
supplying water and water-soluble fertilizer from a nutrient and water reservoir to an irrigation area housing the carrier mixture on the carrier mat;
collecting excess water and water-soluble fertilizer back in the nutrient and water reservoir; and
repeating the steps of supplying the water and water-soluble fertilizer to the irrigation area, and collecting the excess water and water-soluble fertilizer back in the nutrient and water reservoir until the soilless pre-vegetated mat is produced.

The land in the irrigation area 10 is graded to an appropriate slope 9 of about 1° to about 5° or about 2.5° to facilitate drainage and prevent pooling. The irrigation area 10 has dimensions of about 100 feet to about 350 feet×about 100 feet to about 350 feet, or about 150 feet×300 feet; i.e. dimensions of about 0.25 acres to about 1.5 acres, or about 1 acre. Other dimensions would also be suitable depending on the location the system is installed and would be within the ability of the person skilled in the art to choose. In an embodiment, at the lower end of the slope, the land is excavated in a manner which focuses drainage into a single spot. In an embodiment, the underlying soil to be graded has been cleaned to remove large stones which can, for example, puncture the membrane, and adequately compacted in a manner that reduces, for example, the formation of depressions being formed which would allow for pooling of water. The use of sandy loam or sand as the underlying soil to be graded reduces the possibility of large stones and/or similar objects which need to be removed by cleaning, and sandy loam or sand is also easily worked. Further, sandy loam or sand resists compaction well, therefore reducing the potential for depressions forming which would allow for the pooling of water. Accordingly, in a further embodiment, the underlying soil to be graded comprises a sandy loam or sand.

After rough grading, the area is compacted using, for example, a heavy roller and sprayed with water, achieving an approximately smooth uniform surface, free from any substantial amounts of objects or projections which would be expected to puncture the waterproof membrane. For underlying substrates with problematic and moderately rough surfaces, a layer of, for example, peat moss is optionally applied to soften the surface. In an embodiment, peat moss is used, as it is less abrasive than sand on the membrane.

Accordingly, it is an embodiment of the present application that the irrigation area is graded to a slope of about 1° to about 5° or about 2.5°. In another embodiment, the irrigation area has dimensions of about 100 feet to about 350 feet×about 100 feet to about 350 feet, or about 150 feet×300 feet. In an embodiment, the soil in the irrigation area comprises a sandy loam or sand. In an embodiment, a layer of peat moss is placed over the soil in the irrigation area.

The waterproof membrane 1 confines the growing area, and is to be applied over the graded sloped land. In an embodiment, the membrane material is puncture resistant, UV resistant and/or bondable. Multiple products have been shown and/or are expected to work, including, for example traditional flat roofing membranes such as EPDM membranes and vinyl membranes. A variety of manufacturers produce suitable membranes typically used in commercial flat roofing systems, for example, FiberTite™ by Seaman Corporation. In an embodiment, the waterproof membrane 1 is applied up and over a constructed berm barrier 5, and the waterproof membrane is anchored with weight to keep it in place. The weight of the waterproof membrane and/or the membrane with the soilless pre-vegetated mat is enough to keep the system in place within the growing area.

Accordingly, it is an embodiment that a waterproof membrane is under the carrier mat in the irrigation area. In an embodiment, the waterproof membrane is an EPDM membrane or a vinyl membrane.

As shown in FIGS. 1 and 2, it is an embodiment of the present application that a raised berm barrier 5 is constructed around the perimeter of the graded irrigation area 10, reaching a minimum height of about six inches, or about 12 inches. The height is sufficient to adequately retain water in the growing area. In an embodiment, the berm barrier 5 is constructed from earth, although other materials such as cinder blocks, bricks or poured concrete are suitable. In a further embodiment, the berm barrier 5 for growing area containment is a raised perimeter, constructed for the growing area to facilitate, for example, the reuse of water and fertilizers.

Accordingly, it is an embodiment that a raised berm barrier surrounds the irrigation area. In an embodiment, the raised berm barrier has a height between about six inches to about 12 inches. It is an embodiment that the raised berm barrier has a height of about 12 inches. In another embodiment, the raised berm barrier is constructed from a material selected from earth, cinder blocks, bricks or poured concrete.

In an alternative embodiment, instead of a waterproof membrane 1 and berm barrier 5, concrete is used, such as concrete within the confines of a greenhouse, or outdoors. Many commercial greenhouses already have sloped and drainable growing areas made from concrete which would eliminate the need for a waterproof membrane 1 and berm barriers 5 when the processes of the application are used inside the confines of a greenhouse.

Accordingly, it is an embodiment that the irrigation area is comprised of concrete. In another embodiment, the irrigation area comprised of concrete is in a greenhouse.

A person skilled in the art would appreciate that other materials and configurations can be used to form the irrigation area and that the invention is not limited to the specific embodiments disclosed herein.

In an embodiment of the application, an irrigation system (not shown in FIGS. 1 and 2) connected to the nutrient and water reservoir 7 delivers water and water soluble fertilizer to all areas of the irrigation area 10 within the confines of the berm barriers 5. The irrigation system can be varied, for example overhead irrigation, high end irrigation and the like. Sub-irrigation systems can also be used. In a further embodiment, the irrigation system is designed to minimize water use, minimize water loss from overspray, and/or maximize fertilizer use, as all excess irrigation water and water-soluble fertilizer is collected back into the nutrient and water reservoir 7 for reuse. In a controlled environment, an existing irrigation system can, for example, be employed with little modification. The irrigation system should ensure complete coverage of the irrigation area 10 but can vary in nature. For example, the irrigation system can release water and water-soluble fertilizer at the high end of the slope, and the water and water-soluble fertilizer then can be allowed to migrate to the low end. The irrigation can also be a general overhead irrigation system. The irrigation system can also be a combination of an irrigation system that releases water and water-soluble fertilizer at the high end of the slope, and a general overhead irrigation system. Multiple irrigation methods can easily be employed in the same irrigation area 10, and be used in a way that is designed to reduce overspray and maximize water use efficiency as would be known to those skilled in the art. For example, it would be understood that a general overhead irrigation system may waste water via overspray so would not be ideal in windy conditions but when used, the pump “on time” is reduced due to coverage being achieved in less time.

Accordingly, it is an embodiment that the water and water-soluble fertilizer are supplied from the nutrient and water reservoir to the irrigation area using an irrigation system. It is an embodiment that the irrigation system is an overhead irrigation system, a high end irrigation system or a combination of an overhead irrigation system and a high end irrigation system.

In an embodiment, at lower end of the slope 9, under the irrigation area 10 which has been graded to concentrate the flow of water, the large nutrient and water reservoir 7 is buried. The reservoir type is highly varied, but can include, for example a cistern made from, for example, polyvinylchloride (PVC) or high density polyethylene (HDPE) or a liquid transport truck, such as a retired milk truck. Any reservoir of an appropriate size can be used, but it is located at the low end of the sloped growing area, and positioned in such a manner as to efficiently capture the excess irrigation water and water-soluble fertilizer. The size of the reservoir 7 will, for example, depend of the plot size as generally a larger plot will require a larger reservoir. A person skilled in the art would readily understand how to choose and place an appropriate reservoir. The reservoir 7, for example can range from about 10,000 L to about 30,000 L in volume. The waterproof membrane 1 and land are designed to return excess water and water-soluble fertilizer into the nutrient and water reservoir 7 and also have an alternate exit point if the nutrient and water reservoir 7 fills beyond capacity, for example from a rain event or events. For example, the opening 8 at the low end of irrigation area 10 for outside production can comprise this exit point. When production occurs outside, the opportunity exists to capture and use rain water. When the nutrient and water reservoir 7 has reached full capacity from, for example, a rain event, excess water and water-soluble fertilizer from the irrigation area 10 can be redirected out of the irrigation area 10 using the opening 8 to prevent waterlogging of the growing soilless pre-vegetated mats.

Accordingly, it is an embodiment that the irrigation area has an opening which drains the excess water and water-soluble fertilizer into the nutrient and water reservoir. In another embodiment, the irrigation area has a further opening which redirects excess water and water-soluble fertilizer outside of the irrigation area when the nutrient and water reservoir has reached full capacity.

As shown in FIG. 2, it is an embodiment that the system includes an irrigation control and pump 6. Irrigation cycles are triggered here for water and water-soluble fertilizer delivery to the irrigation area 10. The design will depend on the growing situation, for example, whether it is indoors or outdoors. In a further embodiment, the irrigation control and pump 6 include a monitoring station for system vitals such as pH of the reservoir contents, electrical conductivity (EC), parts per million (PPM); a measured value of salts and/or minerals contained in solution, reservoir level and the like. The automatic control system monitors the reservoir level and allows water in from, for example, rain events or diverts it if the nutrient and water reservoir 7 is at full capacity. The monitoring station will give feedback so an operator can make necessary adjustments, for example, when the concentration of water-soluble fertilizer in the nutrient and water reservoir 7 is diluted below threshold limits from, for example, the addition of unfertilized rain water.

Accordingly, it is an embodiment that the irrigation system supplying the water and water-soluble fertilizer to the irrigation area from the nutrient and water reservoir is controlled by an irrigation control and pump. In another embodiment, the irrigation control and pump includes a monitoring station. It is an embodiment that the monitoring station monitors pH, electrical conductivity, PPM and reservoir level.

Sub-irrigation systems can also be used with the processes of the present application. That is, water and water-soluble fertilizer are pumped below the carrier mat in a manner such that the vegetation propagation material is sufficiently exposed thereto (i.e. sufficient to allow propagation). A person skilled in the art would be able to design such an irrigation system based on information available in the art.

### III. Soilless Pre-vegetated Mats of the Application

In the present application, soilless pre-vegetated mats have been produced using the processes of the present application. A number of benefits of the soilless pre-vegetated mats of the present application have been shown and/or are expected over other known mats such as other pre-vegetated mats.

For example, the soilless pre-vegetated mats of the present application have been demonstrated to show weed suppression resulting from the use of a carrier mat made from a material that does not degrade under exterior growing conditions, such as polyethylene terephthalate (PET). Tests conducted for the studies of the present application have indicated that weeds, or weed seeds existing in the for example, roof substrate which the mat is placed over, cannot penetrate the PET or similar mat comprised of a material that does not degrade under exterior growing conditions. If the mat comprises PET having a fine weave, weeds will not be able to penetrate due to this fine weave but grass can still penetrate. Weed seeds falling from the environment would also be expected to have their growth restricted in the soilless pre-vegetated mats of the present application as the soilless pre-vegetated mats are fully vegetated at the time of installation therefore competition factors would be expected to reduce the likelihood of the germination and establishment of weed seeds falling from the environment. Further, even if a weed is established from a weed seed falling from the environment onto a soilless pre-vegetated mat of the present application, such a weed would not be expected to return the following year because it would have to penetrate from below, for example the fine weave of the carrier mat comprising a material that does not degrade under exterior growing conditions after winter dieback. As mentioned above, it has been demonstrated in the studies of the present application, that such growth is restricted. Seed germination from a weed falling from the environment is also reduced, as the seed would not come into contact with the soil because it is restricted by the pre-vegetated mat from doing so. Carrier mats comprised of a material similar to PET should also demonstrate similar weed suppression.

The pre-vegetated mats of the present application are ultra-lightweight and soilless. While a typical worker can handle areas of about 1 m² comfortably with existing pre-vegetated mat systems, the soilless pre-vegetated mats of the present application have a weight of about 2 kg/m², which allows a worker to handle areas of up to about 10 m² or greater. This is expected to speed up harvesting and installation through increased worker efficiency. It also allows for a greater shipping capacity on weight restricted vehicles, for example.

The soilless pre-vegetated mats of the present application have also been demonstrated to be flexible in terms of vegetation species, and vegetation species combinations. It is predicted that virtually any suitable vegetation or vegetation combination can be grown using the processes of the present application, with minimal modification to the parameters used in the processes of the present application.

Further, when PET is used for the carrier mat in the soilless pre-vegetated mats of the present application, it is an embodiment that the soilless pre-vegetated mats are produced from 100% recycled materials. The soilless pre-vegetated mats of the present application also have an exceptionally high tensile strength.

Even further, the soilless pre-vegetated mats of the present application do not contain soil or mineral substrate. Accordingly, this would be expected to allow for easier international shipment provided, for example, that the vegetation of the soilless pre-vegetated mat is not on the noxious weed list of a destination country and the proper documentation has been satisfied.

In an embodiment, the soilless pre-vegetated mats of the present application serve as a pre-vegetated erosion control blanket. In an embodiment, the soilless pre-vegetated mats of the present application contain pre-grown plants which have been shown to securely anchor the underlying substrate in 4-6 days, which is quicker than other known erosion control systems.

Accordingly, the present application includes a pre-vegetated mat, comprising, consisting of or consisting essentially of:
a carrier mat comprised of a material that does not degrade under exterior growing conditions; and
vegetation whose roots intertwine within and under the carrier mat,
wherein the pre-vegetated mat is soilless.

The present application also includes a soilless pre-vegetated mat produced by the processes of the present application.

Polyethylene terephthalate and similar materials, for example other types of film-forming thermoplastic polyesters that do not degrade under exterior growing conditions, or other types of film-forming thermoplastic polymers such as polyethylene, polypropylene, polyvinylchloride (PVC) and nylon are examples of a material that does not degrade under exterior growing conditions. Accordingly, in an embodiment, the carrier mat is comprised of polyethylene terephthalate or a similar material. In another embodiment, the carrier mat is comprised, consists of or consists essentially of polyethylene terephthalate. It is an embodiment that the polyethylene terephthalate or similar material or the polyethylene terephthalate is woven or unwoven. In another embodiment, the carrier mat is comprised of a woven polyethylene terephthalate or similar material. It is an embodiment that the carrier mat is comprised of a woven polyethylene terephthalate. The selection of material used for the carrier mat is based, for example on the intended application and/or the availability of the material, and is within the capability of one skilled in the art.

Sedum sp. can be produced from either cuttings or seed as the vegetation propagation material using the processes of the present application. Several examples of vegetation that was grown using the processes of the present application using vegetation seeds and/or cuttings as the vegetation propagation material are provided in Tables 1 and 3-9. Accordingly, in an embodiment, the vegetation of the soilless pre-vegetated mats of the present application is selected from meadow vegetation, drought tolerant vegetation, grass and Sedum vegetation. In another embodiment, the vegetation is selected from one or more of meadow vegetation, drought tolerant vegetation, Sedum vegetation and grass. In a further embodiment, the vegetation is meadow seed vegetation and drought tolerant vegetation. It is an embodiment that the drought tolerant vegetation is xeri-scaping vegetation.

In an embodiment, the vegetation comprises, consists essentially of or consists of meadow vegetation. It is an embodiment that the meadow vegetation comprises, consists essentially of or consists of Bachelor Buttons (Centaurea cyanus), Black Eyed Susan (Rudbecki hirta), California Poppy (Eschscholtzia rhoes), Evening Scented Primrose (Oenothera biennis), Hard Fescue (Festuca longifolia), Lance Leaf Coreopsis (Coreopsis lanceolata), Scarlet Flax (Linum grandiflorum), Sheep's Fescue (Festuca ovina), Wild Lupine (Lupine perennis) and Yellow Prairie Coneflower (Ratibida columnifera).

In an embodiment, the vegetation comprises, consists essentially of or consists of drought tolerant vegetation. It is an embodiment that the drought tolerant vegetation comprises, consists essentially of or consists of Black Eyed Susan (Rudbecka hirta), Buffalo Grass (Buchloe dactyloides), Common Milkweed (Asclepias syriaca), Evening Scented Primrose (Oenothera biennis), Hoary Vervain (Verbena stricta), Lance Leaf Coreopsis (Coreopsis lanceolata), Sand Dropseed (Sporobolus cryptandra), Ticklegrass (Agrostis scabra), White Yarrow (Achillea millifolium) and Dwarf Plains Coreopsis (Coreopsis tinctoria). In another embodiment, the drought tolerant vegetation comprises, consists essentially of or consists of Black Eyed Susan (Rudbecka hirta), California Poppy (Eschscholtzia rhoes), Bachelor Buttons (Centaurea cyanus), Lance Leaf Coreopsis (Coreopsis lanceolata), Dwarf Plains Coreopsis (Coreopsis tinctoria), Wild Lupine (Lupine perennis), Yellow Prairie Coneflower (Ratibida columnifera), Rocky Mountain Penstemon (Penstemon strictus), Canada Wild Rye (Elymus canadensis), Little Bluestem (Schizachyrium scoparium) and Alpine Aster (Aster alpines).

In an embodiment, the vegetation comprises, consists essentially of or consists of grass. It is an embodiment that the grass comprises, consists essentially of or consists of one or more of Blue Grama (Bouteloua gracilis), Little Bluestem (Schizachyrium scoparium), Canada Wild Rye (Elymus canadensis), Buffalo Grass (Buchloe dactyloides) and Hard Fescue (Festuca longifolia). When the vegetation comprises, consists essentially of or consists of grass, it is an embodiment that the carrier mat is arranged as at least two layers of the material that does not degrade under exterior growing conditions and the roots of the vegetation intertwine within and under the lower layer or layers of the material.

In an embodiment, the vegetation comprises, consists essentially of or consists of Sedum vegetation. In another embodiment, the Sedum vegetation is selected from Sedum album, Sedum spurium, Sedum kamtschaticum, Sedum reflexum, Sedum sexangulare and Sedum hybridum. In a further embodiment of the present application, the Sedum vegetation comprises, consists essentially of or consists of two or more of Sedum album, Sedum spurium, Sedum kamtschaticum, Sedum reflexum, Sedum sexangulare and Sedum hybridum. It is an embodiment that the Sedum vegetation comprises, consists essentially of or consists of Sedum album and Sedum spurium (Royal Pink, Schorbusser Blut, Fuldaglut, Dragons Blood). In another embodiment, the Sedum vegetation comprises, consists essentially of or consists of Sedum kamtschaticum, Sedum reflexum, Sedum sexangulare and Sedum hybridum.

It was observed in the present studies that vegetation mixtures having higher concentrations of Buffalo Grass (Buchloe dactyloides) and/or White Yarrow (Achillea millifolium), for example, vegetation produced from seed mixtures having above about 5 wt % or about 10 wt % of the total mass of seeds therein of Buffalo Grass (Buchloe dactyloides) and/or above about 5 wt % or about 10 wt % of the total mass of seeds therein of White Yarrow (Achillea millifolium), the Buffalo Grass (Buchloe dactyloides) and/or White Yarrow (Achillea millifolium) tended to reduce the population numbers of the other species present as, for example these species were so prolific. Accordingly, in an embodiment, the vegetation is produced from vegetation propagation material comprising, consisting essentially of or consisting of less than about 10 wt % of the total mass of seeds therein of Buffalo Grass (Buchloe dactyloides) seeds. In another embodiment, the vegetation is produced from vegetation propagation material comprising, consisting essentially of or consisting of less than about 5 wt % of the total mass of seeds therein of Buffalo Grass (Buchloe dactyloides) seeds. In an embodiment, the vegetation is produced from vegetation propagation material comprising, consisting essentially of or consisting of less than about 10 wt % of the total mass of seeds therein of White Yarrow (Achillea millifolium) seeds. In another embodiment, the vegetation is produced from vegetation propagation material comprising, consisting essentially of or consisting of less than about 5 wt % of the total mass of seeds therein of White Yarrow (Achillea millifolium) seeds. In a further embodiment, the vegetation is produced from vegetation propagation material comprising, consisting essentially of or consisting of less than about 10 wt % of the total mass of seeds therein of Buffalo Grass (Buchloe dactyloides) seeds and less than about 10 wt % of the total mass of seeds therein of White Yarrow (Achillea millifolium) seeds. It is an embodiment that the vegetation is produced from vegetation propagation material comprising, consisting essentially of or consisting of less than about 5 wt % of the total mass of seeds therein of Buffalo Grass (Buchloe dactyloides) seeds and less than about 5 wt % of the total mass of seeds therein of White Yarrow (Achillea millifolium) seeds.

The vegetation grown from combination 2 set out in Table 8 was observed to be particularly esthetically appealing. Accordingly, in an embodiment, the vegetation is produced from vegetation propagation material comprising, consisting essentially of or consisting of about 5wt% Black Eyed Susan (Rudbecki hirta) seeds, about 5 wt % Bachelor Buttons (Centaurea cyanus) seeds, about 5 wt % California Poppy (Eschscholtzia rhoes) seeds, about 10 wt % Scarlet Flax (Linum grandiflorum) seeds, about 10 wt % Lance Leaf Coreopsis (Coreopsis lanceolata) seeds, about 10 wt % Dwarf Plains Coreopsis (Coreopsis tinctoria) seeds, about 10 wt % Wild Lupine (Lupine perennis) seeds, about 20 wt % Rocky Mountain Penstemon (Penstemon strictus) seeds, about 5 wt % Canada Wild Rye (Elymus canadensis) seeds, about 15 wt % Little Bluestem (Schizachyrium scoparium) seeds and about 5 wt % Alpine Aster (Aster alpines) seeds.

The following non-limiting examples are illustrative of the present application:

### EXAMPLES

### Example 1

### Production of Pre-Vegetated Mats

### Materials and Methods

Six complete trials were performed in the Bovey Greenhouses located at the University of Guelph, in Guelph Ontario, Canada (Lat. 43°31′38.28″N, Long. 80°13′46.64″W). Each trial contained 24 experimental units and lasted for a period of 1-2 months. Further details regarding each of these six trials can be found below. Trials investigated the use of three mat types, 12 plant species combinations and monocultures, six seeding/cutting carrier solution application treatments, with multiple application rates for both seed and carrier solution. Mats used included a non-woven erosion control coir mat (ECM), a mixed coir and straw mat (EM) and polyethylene terephthalate (PET) recycled mats. Bulk mat material was cut into sections measuring about 25 cm by about 50 cm, with a thickness ranging from about 0.5-1 cm. Sections were placed on sloped pieces of plywood which was covered in white plastic. Each unit had three drip lines to deliver water at the high end. A channel was established on the low end which directed the excess water into a reservoir situated below the plots. Over the course of the experiments, 12 species combinations and monocultures were grown. Sedum cuttings were applied to plots at differing rates ranging from the industry standard of about 1.24 kg/m² to low rates of about 250 g/m². Sedum cuttings ranged in size from about 5 cm in length to about 0.5 cm in length. Sedum cuttings were applied without use of a carrier mixture in Trial 1 but were applied mixed into a carrier mixture in subsequent trials. Seed planting densities ranged from about 8 g/m² to about 2 g/m² and were mixed with one of a number of seed application treatments as set out in greater detail below (for example, only water, a liquid hydro-seeding carrier solution developed in the studies of the present application, Fibramulch or Flexterra) at three application rates. The carrier mixture was applied by hand uniformly to the surface of each mat. Further tests included the application of seed between two layers of the PET and application of vegetation propagation material on coir erosion control matting. Irrigation events occurred, for example, at three to four times a day at about 7 am, about 12 pm, and about 5 pm or at about 7 am, about 12 pm, about 5 pm and about 9 pm respectively, or as described below. The length of irrigation events varied from, for example about 5 to about 15 minutes depending on the trial, or as described below. Plots were covered with white shade cloth for a period of 1 week to facilitate germination during the first and second trials, and were not for the remaining trials. Plots were irrigated for the first week with de-ionized water only in trials 1, 4, and 6, while city water was used for the remaining. The reservoir was made to contain, for example a ½ strength fertilizer solution (20Nitrogen-8Phosphorus-20Potassium with micronutrients added at 250 ppm) the second week, and full strength was used for weeks 3, 4, and 5. A modified Hoagland's fertilizer solution was used in the initial trials, and MiracleGro™ was used in the experiments relating to the seed carrier mixture described below. There were no observed differences between the trials using the 20N-8P-20K water-soluble fertilizer with micronutrients added at 250 ppm and the other water-soluble fertilizers used in the present studies. Each mat was monitored for growth on a weekly basis to analyze germination rate, coverage, plant health, and aesthetics. Units were harvested at the end of weeks 4, 5, and 6, depending on the trial. At time of harvest, mats were allowed to dry down to a point which did not impact plants (i.e. no wilting); roughly 10 hours. Mats were all weighed individually then rolled and placed into an about 4-5 degree Celsius cold room for differing time periods. Mats were weighed again after the storage period and placed outside on a growing substrate to monitor survivability. When placed outside, mats were either placed under shade cloth for a period of one week, or were left without shade. Irrigation was provided as needed during the transition period. Rate of root penetration into the substrate was monitored as well as survivability.

### Harvest, Storage and Transplant

Mats with an acceptable level of coverage (about 90-100%) were deemed ready for harvest and storage in an about 4-5° C. cold room for various time periods. Before storage, mats were semi-dried, to a point where no wilting was apparent, recognized by those familiar with the art. Before and after dry down, mats were weighed. The heaviest mats weighed were those which used the recycled newspaper mulch on coir mat with Sedum, and the lightest were the ones which were produced using the hydro-seeding carrier mixture developed in the studies of the present application with a drought tolerant seed blend on PET mats. The heaviest recorded weights were 500 g/mat (4 kg/m²), and the lightest were 277 g/mat (2.2 kg/m²). The mean mass of mats from subsequent trials using only the hydro-seeding carrier mixture developed in the studies of the present application and the PET carrier mat, with all seed and Sedum species was 320 g/mat (2.56 kg/m²). Mass did not deviate after storage treatment.

Mats were stored for time periods ranging from 3-30 days. All treatments survived up to 10 days with little or no impact on plant health or transplant success. From 10-15 days Sedum mats experienced slight yellowing, without impacting transplant success. The herbaceous mats suffered some damage during the 10-15 day storage treatment, but were moderately successful in reestablishment after transplant. Long term survivability of storage for the herbaceous mats appeared to be dependent on the maturity level at harvest of the plants. The more the plant communities were allowed to mature during production, the greater the survival rate. Less mature communities tended to compress over long storage times, resulting in some death of the non-grass species in the mix. This was also true when storage occurred for 30 days. The herbaceous mats at this point were still green, yet the grass species were all that remained viable while the other plants had suffered. More mature communities however, survived better. Sedum mats suffered some damage after 30 days storage, but did contain viable plant material. Although communities survived over 10-15 days in storage, it is not normal for shipping itineraries to require this length of storage. Between 3-5 days shipping is typical and all mats produced were completely unaffected by storage at this length of time.

Transplant success was 100% with the Sedum mats when planted outside. Survivability was consistent whether the mats were shaded to reduce transplant stress or were not shaded. Irrigation was provided, as needed, for the first 5 days. Sedum roots were seen to develop into the underlying substrate within 2 days after transplant, and within 4-5 days, the mats could not be removed without mechanical damage to the root structure. Transplant success was achieved with the herbaceous mats when proper irrigation was maintained during the establishment period and shade cloth was employed for the first 5 days. It is expected that when production is taking place outside in full sun, the need for a shade cloth may not be needed as the plant communities are already adapted to the intensity of direct sunlight. Roots were seen to penetrate into the underlying substrate two days after transplant, and mats were mechanically fixed to the substrate within 4-6 days. Due to the shallow substrate the mats were placed on (about 5-6 cm, or as otherwise indicated below), once plants were established, irrigation was needed every about 4-5 days or else wilting occurred, depending on the temperature, cloud cover, and rain levels.

### Carrier Mat Type (Mat Products)

Carrier mat products made out of three different types of materials were studied. Recycled polyethylene terephthalate (PET) mats of multiple thicknesses, a mixed coir and straw mat, and a coir mat were used in the trials undertaken. All mat types produced plants with the same relative density covers, in similar time frames. However, PET was a more optimal matting material. PET mats can have the added benefits of being completely recycled, low cost, readily available, non-degradable under exterior growing conditions, and are a sustainable product. PET carrier mats can be obtained in a variety of thicknesses. At even the low thicknesses, indications of weed suppression abilities were clear, and with the thicker mats (1 cm) the properties were even more evident in this regard. Because the PET does not degrade under exterior growing conditions, these suppression properties would be long lasting and of great benefit to both green roof application, and other turf applications, for example erosion control.

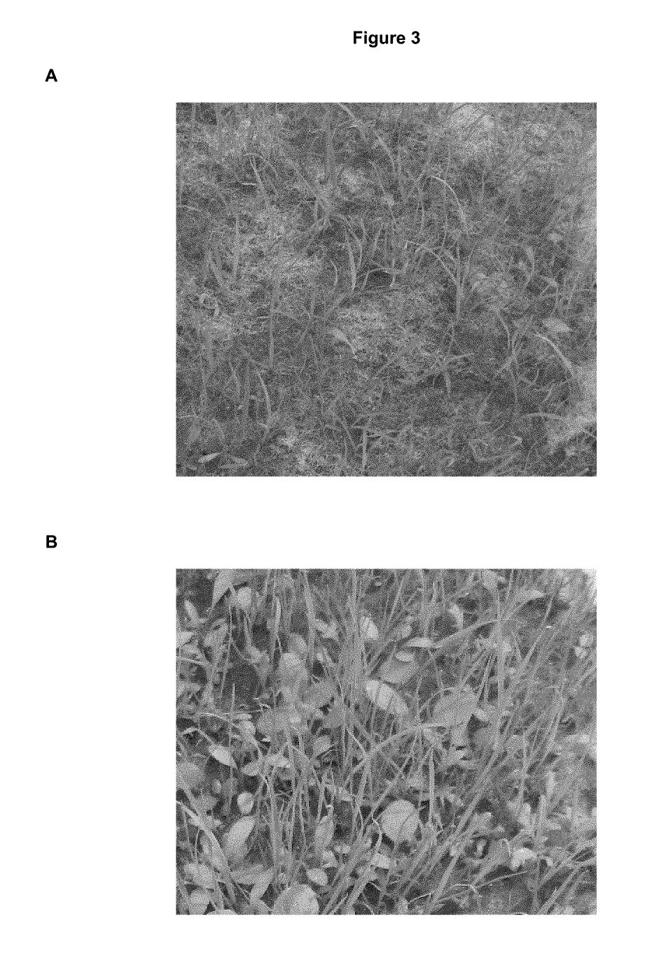

A carrier mat comprised of PET having a fine weave is expected to provide a long term barrier for under mat weed seed germination while selectively allowing grasses to penetrate. FIG. 3 shows a comparison between meadow seed mixture germination and growth when an additional layer of PET is placed over a carrier mat comprising PET (FIG. 3A) and without (FIG. 3B).

To produce the pre-vegetated mats shown in FIGS. 3A and 3B, 1 gram of meadow seed mixture was used. In the pre-vegetated mat of FIG. 3A, the meadow seed mixture was between the layers of PET. FIG. 3B shows an example of meadow seed vegetation. FIG. 3A demonstrates that only the grass in the meadow seed mixture can grow through the overlying PET mat therefore mats comprising a similar carrier mat as that used for the top layer in FIG. 3A would be expected to suppress weed growth from seeds under the carrier mat while selectively facilitating grass growth from underlying seeds. It is expected that the thicker the carrier mat used in a soilless pre-vegetated mat, the more pronounced the weed suppression would be.

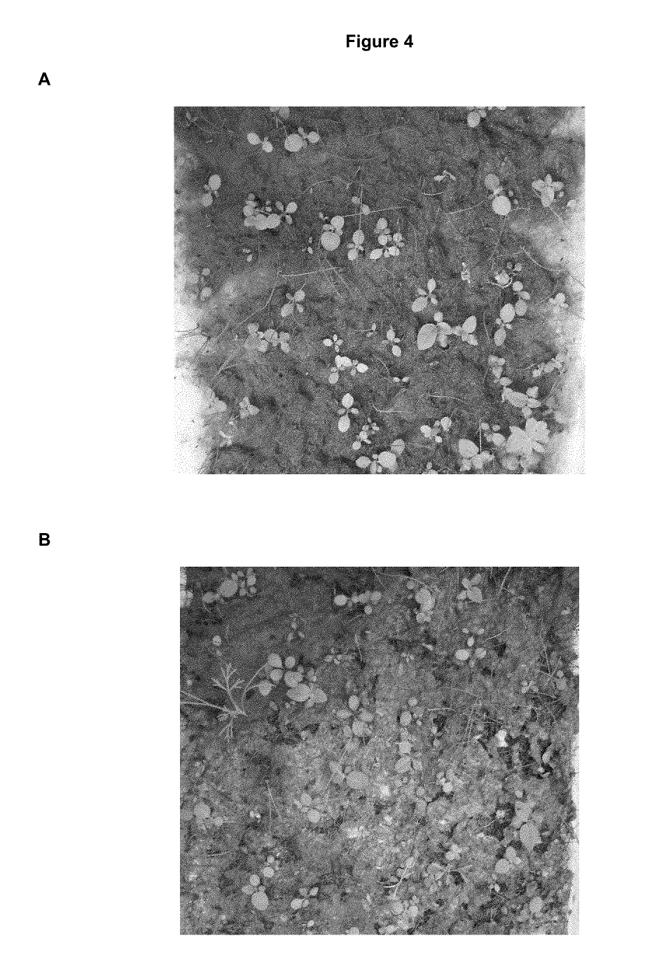

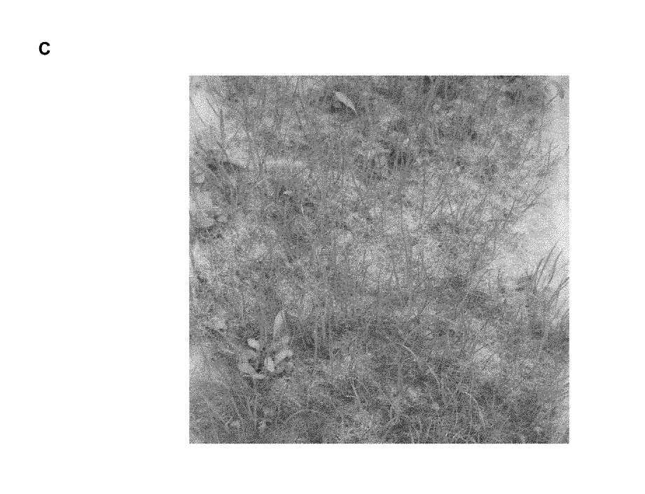

FIG. 3A also demonstrates the reduction of algae growth of the carrier mixtures of the present application in comparison to the commercially available carrier mixtures Flexterra and Fibramulch, described below and shown in FIGS. 4A and 4B.

While mats using a carrier mat comprised of a material that does degrade under exterior growing conditions, for example, organic-based mats have been reported to be effective at weed suppression, such mats only provide a temporary solution to weed control. Further, such organic-based mats are not produced fully vegetated therefore the above-discussed suppression of weeds growing from weed seeds falling from the environment due to competition with the vegetation of the mat would be less effective.

PET also produced a very rigid and durable finished product which could not be torn, even well beyond normal handling stresses. It is expected that other materials having similar properties to PET, for example, a material that does not degrade under exterior growing conditions, and that can be formed into a carrier mat for pre-vegetated mats could also be used.

### Seed/Cutting Carrier Mixture

The seed and/or cutting carrier mixture was a component of the developed system as germination was shown to be reduced without its provided support. While not wishing to be limited by theory, the applied product facilitated growth and germination in a number of ways. Initially, its use is important in the dispersion of seeds and cuttings. In a production setting, quantities of seeds and/or cuttings are mixed in a large vessel with water and the other components of the carrier mixture. This agitated carrier mixture is then sprayed over the carrier mat material uniformly. Once sprayed, the carrier mixture fixes the seed to the mat material, preventing loss from wind, erosion, or loss from bird life. Further, if a water-absorbing polymer, for example a polyacrylamide having, for example, a small particle size is added to the solution, its moisture retention abilities facilitate seed germination and water use efficiency once plants are more established. Sedum cuttings were applied without use of a carrier mixture in Trial 1 but were applied mixed into a carrier mixture in subsequent trials. A number of positive differences were observed in the trials using a carrier mixture to apply the Sedum cuttings. For example, the speed of application and production was increased when a carrier solution was used. With a carrier solution, it was also observed that fewer cuttings needed to be applied, and the cuttings applied could be of a significantly smaller size. Further studies regarding the carrier mixture are detailed below in Section A.

### Conclusion

The above results indicate that a soilless, pre-vegetated mat can be produced on a carrier mat made from synthetic recycled PET, or a similar material that does not degrade under exterior growing conditions. Through using either seed or, for example Sedum sp. cuttings, applied in conjunction with a formulated carrier mixture, the carrier mats can be populated with a diverse range of tested plant species. When grown using an NFT technique, this process produces soilless pre-vegetated matting in about 4-5 weeks, which is ultra-light weight and involves low labor and little infrastructure. The described carrier mat's versatility in producing soilless pre-vegetated mats with diverse plant species has many applications including green roof plant establishment, erosion control, sod production with built in weed barrier, pre-grown perennial gardens, and pre-grown vegetable and herb gardens. As the resulting product is free from, for example soil and soil microorganisms, the fully vegetated soilless pre-vegetated mat is free to cross international borders provided that, for example, the vegetation of the soilless pre-vegetated mat is not on the noxious weed list of a destination country and the proper documentation has been satisfied.

For pre-vegetated green roofs, the soilless pre-vegetated mat grown on a carrier mat of PET or similar material offers many advantages over existing systems. For example, it is a fraction of the weight, and is produced in less than a third of the time. Its production also uses far less resources, in terms of water, fertilizer, labor, seeds and/or cuttings and shipping costs than known mats. Current trends in the North American green roof market indicate that consumers desire a greater diversity of plant species to occupy their roof space, as the functioning of the green roof is superior with diverse plantings. Consumers often also favor pre-vegetated systems. The presently disclosed processes for producing soilless pre-vegetated mats are able to accommodate those needs, while at the same time also offering traditional plantings, for example, using Sedum sp.

When used in the production of grass sod, for example, the soilless pre-vegetated mats of the present application are also lighter than currently used products. Further, the soilless pre-vegetated mats of the present application are the only products which also have a long-term weed barrier built in, which restricts weed development from, for example, seeds existing in the substrate material on which the soilless pre-vegetated mats are placed.

Details of the various studies and trials that were performed are provided below.

### A. Studies of the Effect of Different Carrier Mixtures.

Various methods were used in the trials of the present application for the dispersion of seeds and/or cuttings onto the carrier mats. The vegetation propagation material delivery treatments (carrier mixtures) were designed to accomplish a number of goals, including being a medium for evenly dispersing the vegetation propagation material on the carrier mat, physically affixing the vegetation propagation material to the carrier mat, providing plant nutrients beneficial to vegetation propagation material germination and/or growth, and where the vegetation propagation material comprises seeds, to provide the developing seeds with moisture for germination between irrigation events. All carrier mixtures tested were designed to be applied via hydro-seeding equipment. The use of such hydro-seeding equipment is known in the art.

The present trials conducted utilized 5 main carrier mixtures: two commercially available hydro-seeding mulches (Flexterra and Fibramulch™), two formulations developed specifically for the present trials, and the use of only water. Flexterra and Fibramulch are commercially available solutions for erosion control. Flexterra is composed of thermally processed wood fibers, a wetting agent/tackifying agent, man-made biodegradable fibers and ceramic particles while Fibramulch is composed of recycled paper cellulose (newspaper mulch) and a tackifying agent. These two products are designed to be mixed with water, seeds, and fertilizer in a large vessel then sprayed onto steep, vegetation-bare slopes. Flexterra and Fibramulch are not known to be typically used for the application of cuttings. The combination of wood fibers (Flexterra) or newspaper mulch (Fibramulch) and tackifying agent forms a matrix which prevents erosion off of slopes and facilitates seed germination.

Although both Flexterra and Fibramulch facilitated growth of all vegetation propagation materials tested in the pre-vegetated mats and processes of the present application, they were not optimal for such pre-vegetated mats and processes therefore custom formulated products were created. For example, the processes for producing soilless pre-vegetated mats of the present application were primarily designed to occur on a modest slope, making the high concentration of fiber present in Flexterra and Fibramulch (designed for steep slopes) not necessary, and an added expense to the pre-vegetated mat producer. Furthermore, the addition of organic material (wood fibers and/or newspaper mulch) on the surface of the carrier mat was found to increase the occurrence of algae growth during production. See, for example FIG. 4. Although the algae growth does not damage vegetation growth per se, it does consume valuable nutrients otherwise taken up by vegetation, and is generally considered to be a nuisance. The final weights of the pre-vegetated mats which were produced using Flexterra and Fibramulch were also higher than those which did not contain these commercially available products, as they tended to unnecessarily retain water for extended lengths of time, and the organic material contained therein was found to be substantially still intact and present at time of harvest.

In light of the above-discussed disadvantages of Flexterra and Fibramulch, several custom formulations were developed and tested which did not contain, or contained very little, fiber material (Table 2). These carrier mixtures were composed of water, a tackifying agent, a water-absorbing polymer, vegetation seeds, and a water-soluble fertilizer. The carrier mixtures were shown to sufficiently serve the purposes of affixing the vegetation seeds to the carrier mat, providing water between irrigation events, providing initial fertilization, and reducing the occurrence of algae growth on the surface of the carrier mat during plant propagation (FIG. 4). From the initial laboratory experimentation with the carrier mixtures described in Table 2, the two carrier mixtures which were chosen for the greenhouse mat growth trials described herein were mixes 6 and 7. The pre-vegetated mat shown in FIG. 4C was produced using mix 6 of Table 2.

Mixtures 6 and 7 were found to perform as well as the commercially available hydro-seeding mixtures for producing plants, yet were significantly cheaper, as there was no mulch material present. They produced a finished product which was lighter in weight, and did not exhibit the prolific algae growth documented on the commercially available products. See, for example, FIG. 4.

Some of the seed carrier mixtures produced in the laboratory (for example, Table 2, mixtures 1 and 2) had additional amounts of PET fiber mixed with the intention that the combination of fiber and tackifier would better adhere to the carrier mat than just tackifier alone would. In the present studies, there were no advantages observed to be demonstrated by the addition of these PET fibers. However, in a production setting utilizing steeper slopes, the addition of fibers such as these PET fibers may prove to be advantageous. In a production scenario, there would also regularly be significant amounts of waste PET from production and cutting of the PET carrier mat that would otherwise be considered waste. As there were no negative ramifications from its inclusion to the seed carrier mixture, it is recommended as a means to utilize waste and add additional structural integrity to the carrier mat and matrix thereon.

B: Trial 1 (start date May 26, 2011)

The 24 different combinations listed in Table 3 were tested in a greenhouse (indoor) setting for the production of pre-vegetated mats therefrom. See Tables 4 and 5 for the components of the meadow seed mixture and the xeri-scaping (drought tolerant) seed mixture.

Each prototype pre-vegetated mat was grown in a 0.25 m×0.51 m plastic tray and irrigated via a nutrient film technique (NFT) system constructed for the experiment. For combinations having a carrier mat, sections of PET, ECM (commercially available coir erosion control) or EM (mixed coir and straw) mat were cut to the tray size and then a carrier mixture was then applied to the carrier mat. For combinations having no carrier mat, the carrier mixture was applied directly to the tray.

The carrier mixture for each tray was mixed separately in a container prior to application. The Fibramulch treatment mixture contained 30 g of Fibramulch and 1 g of seeds added to 900 ml of water. Flexterra mixtures contained 20 g of Flexterra and 1 g of seeds added to 600 ml of water. This seed application rate was derived from doubling the advised rate (250 g/90 m²) to give 0.708 g/tray (500 g/90 m²), and then rounding up to 1 g/tray (706 g/90 m²). A higher application rate was used in order to optimize the chance of establishment and maximize coverage. Mixtures were stirred until the organic fibres that were in the Fibramulch and Flexterra products were separated and suspended in a pulp. Subsequently, the carrier mixture was poured onto the mat, 200 ml of water poured over, and coverage evened out by hand. Cuttings for the Sedum treatments were applied the following day at a rate of 80 g/tray for just Sedum mats and 40 g/tray for xeri-scaping seed mixture/Sedum mats. In this trial, the Sedum cuttings were not applied in a carrier mixture; the Sedum cuttings were laid on top of the carrier mat. In subsequent trials, a carrier mixture was used to apply the Sedum cuttings, and the above-discussed advantages were observed.

Treatment trays were mounted on boards oriented in 2 rows of 12 in order to prevent distortion of the tray plastic and the resultant uneven irrigation expected from such distortion. The boards were sloped up towards a centre irrigation hose at an average slope of about a 4° angle. This slope may be expected to be higher than optimal in a larger scale production scenario. Irrigation was applied via 3 drip tubes anchored at the top of each tray with 5 perforations at the tray bottom to allow for water runoff. Runoff was collected in a basin and subsequently reused for irrigation.

Irrigation was not applied for about the first week after mat construction. During this time, germination lids were placed on the trays. The lids were removed from a particular tray when the majority of seeds on that tray had germinated. Individual trays were misted with deionized water when they appeared dry. Irrigation was started on June 2. Three 10L buckets of deionized water and 1 bucket of full strength modified Hoagland's fertilizer solution were added to the reservoir, to give an irrigation solution of 25% modified Hoagland's. Optimal irrigation frequency was determined through observing treatment response during the first week of irrigation. The optimal irrigation schedule ended up being 3 minutes at 9:00 am and 3 minutes at 3:00 pm. On June 17, another bucket of modified Hoagland's fertilizer solution was added to give a 40% fertilizer solution. PPM, pH and EC measurements were taken every 3 days to make sure they stayed about uniform.

Although no formal measurements were taken during production of the pre-vegetated mats, relative qualitative observations were made as needed. Trays were observed approximately every 3 days and significant changes recorded. Observations were made regarding: relative performance of pre-vegetated mat components (for example, carrier mat, binding agent, or vegetation components), relative performance of overall treatment, specific problems with certain treatments/pre-vegetated mat components and overall production problems (for example, pests). Photographs of the pre-vegetated mats were taken every 2 weeks. The pre-vegetated mats were determined to be ready for transplant when vegetation and root network coverage were complete.

Following production, the ability of the pre-vegetated mats to survive storage and establish on a substrate was evaluated. Fully-grown pre-vegetated mats were removed from the irrigation system, left to dry until standing water was removed, and weighed. The pre-vegetated mats were then stored in an about 4° C. cold room for 2 days to simulate storage during transport. On the third day, the pre-vegetated mats were removed, weighed again, and transplanted onto about 6 cm of substrate. The performance of the transplanted pre-vegetated mats (survival, plant health, and ability to attach to substrate) was observed and qualitative observations were recorded.

C: Trial 2 (start date Jul. 29, 2011)

The 24 different combinations listed in Table 6 were tested in a greenhouse (indoor) setting for the production of pre-vegetated mats therefrom. See Tables 4 and 5 for the components of the meadow seed mixture and the xeri-scaping (drought tolerant) seed mixture.

Sections of PET and were cut to tray size and the appropriate carrier mixture was then applied. Prior to application, the mixture for each tray was mixed separately in a container. The Fibramulch treatment mixture contained 30 g of Fibramulch and 1 g of seeds added to 900 ml of water. Flexterra mixtures contained 20 g of Flexterra and 1 g of seeds added to 600 ml of water. Each tray was covered in white shade cloth for a period of 1 week. The Sedum mixtures in this trial received the same treatment as the seeds.

Each prototype mat was grown in a 0.25 m×0.51 m plastic tray and irrigated via a nutrient film technique (NFT) system constructed for the experiment. A modified Hoagland's fertilizer solution was added to the reservoir, to give an irrigation solution of 25% modified Hoagland's. Irrigation occurred twice a day for 3 min.

Following production, the ability of the pre-vegetated mats to survive storage and establish on a substrate was evaluated. Fully-grown pre-vegetated mats were removed from the irrigation system, left to dry until standing water was removed, and weighed. The pre-vegetated mats were then stored in an about 4° C. cold room for 5 days to simulate storage during transport. On the sixth day, the pre-vegetated mats were removed, weighed again, and transplanted onto about 6 cm of substrate. The performance of the transplanted pre-vegetated mats (survival, plant health, and ability to attach to substrate) was observed and qualitative observations recorded.

D: Trial 3 (start date Nov. 9, 2011)

The 24 different combinations listed in Table 7 were tested in a greenhouse (indoor) setting for the production of pre-vegetated mats therefrom. See Tables 4 and 5 for the components of the meadow seed mixture and the xeri-scaping (drought tolerant) seed mixture.

In this trial, the growth of the pre-vegetated mats within trays was eliminated. The carrier mats were placed directly on a sloped waterproof surface.

Irrigation was not applied for about the first week after mat construction. During this time, individual growing pre-vegetated mats were misted with deionized water when they appeared dry. Plots were not covered in shade cloth. Once irrigation was started, the irrigation water used was city water, not deionized. The irrigation frequency was increased to three times a day in this trial. In line greenhouse fertilized water (20N-8P-20K) was added to reservoir after 10 days at a rate of 1 part fertilized water to three parts city water.

Following production, the ability of the pre-vegetated mats to survive storage and establish on a substrate was evaluated. Fully-grown pre-vegetated mats were removed from the irrigation system, left to dry until standing water was removed, and weighed. The pre-vegetated mats were then stored in an about 4° C. cold room for two time periods; some for 1 week and some for 2 weeks to simulate long-term storage and transport. On the 7^{th} and 14^{th} days, the pre-vegetated mats were removed, weighed again, and transplanted onto about 4 cm of substrate. The performance of the transplanted pre-vegetated mats (survival, plant health, and ability to attach to substrate) was observed and qualitative observations were recorded.

### E: Trial 4 (Start Date Dec. 15, 2011)

This trial focused on investigating new plant mixtures beyond those standard combinations used in Trials 1-3. It was seen that previous mixtures which contained grasses (the meadow and xeri-scaping seed mixtures) possessed a proportion of grasses which did not optimally facilitate the growth and development of the other species present. For example, it was observed that vegetation mixtures having higher concentrations of Buffalo Grass (Buchloe dactyloides) and/or White Yarrow (Achillea millifolium), for example, concentrations of above about 5% or about 10%, the Buffalo Grass (Buchloe dactyloides) and/or White Yarrow (Achillea millifolium) tended to reduce the population numbers of the other species present as, for example these species were so prolific. Two combinations were thus created which contained some herbaceous species that were previously tested and others which were new to this set of trials (Table 8).

Each of the new species combinations shown in Table 8 was planted in 2 densities (0.5 g/mat, 1 g/mat) in triplicate on a PET mat for a total of 12 mats. Seed mixtures used in previous trials (meadow seed mixture and xeri-scaping seed mixture) were planted at a single density (0.5 g/mat) and in triplicate. The remaining six plots had mixed Sedum species cuttings placed on top at densities of 156 g/tray, 79 g/tray, and 25 g/tray with two replicates each.

All treatments used 20 g of the commercially available Flexterra as a carrier mixture.

Irrigation was not applied for about the first week after mat construction. During this time, individual trays were misted with city water when they appeared dry. Plots were not covered in shade cloth. Once irrigation was started, the irrigation water used was city water. Irrigation occurred three times a day. In line greenhouse fertilized water (20N-8P-20K) was added to the reservoir after 10 days at a rate of 1 part fertilized water to three parts city water. After 20 days, the fertilizer rate increased to 1 part fertilized greenhouse water, to 1 part city water. When the pre-vegetated mats were fully developed after 35 days, irrigation was reduced to once per day for 3 days. Irrigation was withdrawn completely for a period of 24 hours to induce a drought response from the planted mats, after which, plots were irrigated to assess recovery potential. Once recovery occurred, plots were not irrigated again for 48 hours, then irrigated to again assess recovery potential. At the completion of the trial, the non-Sedum mats were not weighed and were not placed into storage or planted as previous trials had done. Sedum mats were left on the growing platform when the experiment ended, and continued to be grown through Trial 5.

### F: Trial 5 (Start Date Feb. 4, 2012)

Trial 5 focused on the refinement of previously used seed mixtures and the development of new mixtures. The species combinations used are outlined in Table 9. Combinations 1 and 2 were planted in two different density treatments of seeds; 0.25 g/tray and 0.5 g/tray. Combination 2 contained the same mass of Sedum cuttings for both planted combinations. Combinations 3 and 4 were planted at one density (0.25 g/tray) with two replications each. Combination 6 was planted in two seeding densities (0.25 g/tray and 0.5 g/tray) with the fraction of Sedum cuttings remaining the same for both density treatments. Combination 7 had the buffalo grass planted at two seed densities; 0.25 g/mat and 0.5 g/mat with two replications. The remaining plots were occupied by Sedum from the previous trial.

All treatments used 20 g of the commercially available Flexterra as a carrier mixture.

Irrigation was not applied for about the first week after mat construction. During this time, individual trays were misted with city water when they appeared dry. Plots were not covered in shade cloth. Once irrigation was started, the irrigation water used was city water. Irrigation occurred two times a day. In line greenhouse fertilized water (20N-8P-20K) was added to the reservoir after 10 days at a rate of 1 part fertilized water to three parts city water. After 20 days, the fertilizer rate was increased to 1 part fertilized greenhouse water, to 1 part city water. The pre-vegetated mats were grown for 48 days; a duration of time exceeding the previous trials. Sedum mats were again not harvested at trial completion. Upon completion of the trial, non-Sedum mats were weighed and stored for 1 week, 2 weeks, and one month.

### G: Trial 6 (Start Date Mar. 18, 2012)

Trial 6 was a combination of Trials 4 and 5 with representative treatments from both. All species combinations from Table 8 were used with planting densities at 0.25 g/mat and 0.5 g/mat in triplicate. From Table 9, combinations 2, 4, 5, and 6 were used in a single planting density of 0.25 g/mat with three replications each. Sedum cuttings used for combinations 2 and 6 were 2.5 grams/per species per mat. All treatments used 20 g of the commercially available Flexterra as a carrier mixture.

Irrigation was not applied for the first week after mat construction. During this time, individual trays were misted with city water when they appeared dry. Plots were not covered in shade cloth. Once irrigation was started, the irrigation water used was city water. Irrigation occurred two times a day. In line greenhouse fertilized water (20N-8P-20K) was added to the reservoir after 10 days at a rate of 1 part fertilized water to three parts city water. After 20 days, the fertilizer rate was increased to 1 part fertilized greenhouse water to 1 part city water. The pre-vegetated mats were grown for 35 days. Upon completion of the trial, all mats were weighed and stored for 1 week, 2 weeks, and one month.

While the present application has been described with reference to the examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

TABLE 1

| Name | Vegetation* |
|---|---|
| Meadow Seed Mixture | Bachelor Buttons (Centaurea cyanus) |
| | Black Eyed Susan (Rudbecki hirta) |
| | California Poppy (Eschscholtzia rhoes) |
| | Evening Scented Primrose (Oenothera biennis) |
| | Hard Fescue (Festuca longifolia) |
| | Lance Leaf Coreopsis (Coreopsis lanceolata) |
| | Scarlet Flax (Linum granditiorum) |
| | Sheep's Fescue (Festuca ovina) |
| | Wild Lupine (Lupine perennis) |
| | Yellow Prairie Coneflower (Ratibida columnifera) |
| Drought Tolerant Seed Mixture | Black Eyed Susan (Rudbecka hirta) |
| (Xeri-scaping Seed Mixture) | Buffalo Grass (Buchloe dactyloides) |
| | Common Milkweed (Asclepias syriaca) |
| | Evening Scented Primrose (Oenothera biennis) |
| | Hoary Vervain (Verbena stricta) |
| | Lance Leaf Coreopsis (Coreopsis lanceolata) |
| | Sand Dropseed (Sporobolus cryptandra) |
| | Ticklegrass (Agrostis scabra) |
| | White Yarrow (Achillea millifolium) |
| | Dwarf Plains Coreopsis (Coreopsis tinctoria) |
| Drought Tolerant Seed Mixture 2 | Black Eyed Susan (Rudbecka hirta) |
| | California Poppy (Eschscholtzia rhoes) |
| | Bachelor Buttons (Centaurea cyanus) |
| | Lance Leaf Coreopsis (Coreopsis lanceolata) |
| | Dwarf Plains Coreopsis (Coreopsis tinctoria) |
| | Wild Lupine (Lupine perennis) |
| | Yellow Prairie Coneflower (Ratibida columnifera) |
| | Rocky Mountain Penstemon (Penstemon strictus) |
| | Canada Wild Rye (Elymus Canadensis) |
| | Little Bluestem (Schizachyrium scoparium) |
| | Alpine Aster (Aster alpines) |
| Grass (mixed and individually grown) | Blue Grama (Bouteloua gracilis) |
| | Little Bluestem (Schizachyrium scoparium) |
| | Canada Wild Rye (Elymus canadensis) |
| | Buffalo Grass (Buchloe dactyloides) |
| | Hard Fescue (Festuca longifolia) |
| Sedum Mixture 1 | Sedum album |
| | Sedum spurium (Royal Pink, Schorbusser Blut, |
| | Fuldaglut, Dragons Blood) |
| Sedum Mixture 2 | Sedum kamtschaticum |
| | Sedum reflexum |
| | Sedum sexangulare |
| | Sedum hybridum |

*Plants successfully grown in research trials of the present application.

TABLE 2
Carrier mixtures formulated and tested in the laboratory for application
of seeds to a carrier mat

| Ingredient¹ | Mix 1 | | Mix 2 | | Mix 3 | | Mix 4 | | Mix 5 | | Mix 6 | | Mix 7 | | Mix 8 | | Mix 9 | |
|---|---|---|---|---|---|---|---|---|---|---|---|---|---|---|---|---|---|---|
| Water | 1 | L | 1 | L | 1 | L | 1 | L | 1 | L | 1 | L | 1 | L | 1 | L | 1 | L |
| Plantago | | | | | | | 5 | g | | | 3 | g | | | | | 8 | g |
| Potato starch | | | | | | | | | 5 | g | | | 3 | g | 8 | g | | |
| PAM² small | | | | | 2.5 | g | | | | | | | | | | | | |
| PAM² fine | 4.5 | g | 2.5 | g | 2.5 | g | | | | | 2.5 | g | 2.5 | g | | | | |
| 20N-4P-16K³ | 1 | g | 1 | g | 1 | g | 1 | g | 1 | g | 1 | g | 1 | g | 1 | g | 1 | g |
| Seeds | 1 | g | 1 | g | 1 | g | 1 | g | 1 | g | 1 | g | 1 | g | 1 | g | 1 | g |
| PET fibers | 0.25 | g | 0.5 | g | | | | | | | | | | | | | | |

¹Ingredients were mixed into 1 L batches.
²Polyacrylamide (a water absorbing-polymer); a synthetic tackying agent and wetting agent used in two sizes: small (about 0.3-1 mm) and fine (powder, about ≤ 0.3 mm).
³Fertilizer used was water-soluble MiracleGro ™ All-Purpose, with a recommend mixing rate of 22 mL/6 L.

TABLE 3

| | | Carrier Mixture¹ | |
|---|---|---|---|
| No. | Carrier Mat | Vegetation Propagation Material | Binding Agent |
| 1 | ECM² | Xeri-scaping seed mixture | Fibramulch |
| 2 | ECM | Xeri-scaping seed mixture + | Fibramulch |
| | | Sedum mixture⁷ | |
| 3 | ECM | Meadow seed mixture | Fibramulch |
| 4 | ECM | Xeri-scaping seed mixture | Flexterra |
| 5 | ECM | Xeri-scaping seed mixture + | Flexterra |
| | | Sedum mixture | |
| 6 | ECM | Meadow seed mixture | Flexterra |
| 7 | | Meadow seed mixture | Flexterra |
| 8 | PET (thin)³ | Xeri-scaping seed mixture | Fibramulch |
| 9 | PET (thin) | Meadow seed mixture | Fibramulch |
| 10 | PET (thin) | Meadow seed mixture | none⁹ |
| 11 | PET (thick)⁴ | Meadow seed mixture | none |
| 12 | PET (layered)⁵ | Meadow seed mixture | none |
| 13 | PET (thin) | Meadow seed mixture | Flexterra |
| 14 | PET (thick) | Meadow seed mixture | Flexterra |
| 15 | PET (layered) | Meadow seed mixture | Flexterra |
| 16 | PET (thin) | Xeri-scaping seed mixture | Flexterra |
| 17 | PET (thick) | Xeri-scaping seed mixture | Flexterra |
| 18 | PET (layered) | Xeri-scaping seed mixture | Flexterra |
| 19 | EM⁸ | Sedum mixture | Flexterra |
| 20 | PET (thin) | Sedum mixture | Flexterra |
| 21 | EM | Sedum mixture | Fibramulch |
| 22 | PET (thin) | Sedum mixture | none |
| 23 | | Sedum mixture | Flexterra |
| 24 | Roll 'N Grow⁶ | | |

¹Carrier mixture also contained water (900 ml for Fibramulch carrier mixtures and 600 ml for Flexterra carrier mixtures).
²Commercially available erosion control coir mat.
³Woven polyethylene terephthalate mat having a thickness of about 0.5 cm.
⁴Woven polyethylene terephthalate mat having a thickness of about 1.0 cm.
⁵Two layers of polyethylene terephthalate mat; each having a thickness of about 0.5 cm. The carrier mixture was placed in between the PET carrier mats.
⁶Commercially available Roll 'N Grow ™ wildflower mat; not observed to grow under the conditions used in the present study.
7Sedum mixture had Sedum kamtschaticum, Sedum reflexum, Sedum sexangulare and Sedum hybridum cuttings.
⁸Mixed coir and straw mat.
⁹250 mL of water was used in the treatments having no binding agent.

TABLE 4
Meadow seed mixture

| Common name (species) | Mass of seed (%) |
|---|---|
| Bachelor Buttons (Centaurea cyanus) | 10 |
| Black Eyed Susan (Rudbecki hirta) | 10 |
| California Poppy (Eschscholtzia rhoes) | 10 |
| Evening Scented Primrose (Oenothera biennis) | 10 |
| Hard Fescue (Festuca longifolia) | 10 |
| Lance Leaf Coreopsis (Coreopsis lanceolata) | 10 |
| Scarlet Flax (Linum grandiflorum) | 10 |
| Sheep's Fescue (Festuca ovina) | 10 |
| Wild Lupine (Lupine perennis) | 10 |
| Yellow Prairie Coneflower (Ratibida columnifera) | 10 |

TABLE 5
Xeri-scaping seed mixture

| Common name (species) | Mass of seed (%) |
|---|---|
| Black Eyed Susan (Rudbecki hirta) | 10 |
| Buffalo Grass (Buchloe dactyloides) | 10 |
| Common Milkweed (Asclepias syriaca) | 10 |
| Dwarf Plains Coreopsis (Coreopsis tinctoria) | 10 |
| Evening Scented Primrose (Oenothera biennis) | 10 |
| Hoary Vervain (Verbena stricta) | 10 |
| Lance Leaf Coreopsis (Coreopsis lanceolata) | 10 |
| Sand Dropseed (Sporobolus cryptandra) | 10 |
| Ticklegrass (Agrostis scabra) | 10 |
| White Yarrow (Achillea millifolium) | 10 |

TABLE 6

| | Carrier | Carrier Mixture | | | |
|---|---|---|---|---|---|
| No. | Mat | Binding Agent | Vegetation Propagation Material | Seed/Cutting Density | |
| 1 | PET* | Flexterra¹ | Xeri-scaping seed mixture | 0.35 | g/tray** |
| 2 | PET | Flexterra | Xeri-scaping seed mixture | 0.5 | g/tray (353 g/90 m²) |
| 3 | PET | Flexterra | Xeri-scaping seed mixture | 0.75 | g/tray |
| 4 | PET | Flexterra | Xeri-scaping seed mixture | 1 | g/tray |
| 5 | PET | Flexterra | Meadow seed mixture | 0.35 | g/tray** |
| 6 | PET | Flexterra | Meadow seed mixture | 0.5 | g/tray |
| 7 | PET | Flexterra | Meadow seed mixture | 0.75 | g/tray |
| 8 | PET | Flexterra | Meadow seed mixture | 1 | g/tray |
| 9 | PET | Flexterra | Xeri-scaping seed mixture | 0.25 | g/tray |
| | | | Meadow seed mixture | 0.25 | g/tray |
| 10 | PET | Flexterra | Xeri-scaping seed mixture | 0.125 | g/tray |
| | | | Meadow seed mixture | 0.375 | g/tray |
| 11 | PET | Flexterra | Xeri-scaping seed mixture | 0.375 | g/tray |
| | | | Meadow seed mixture | 0.125 | g/tray |
| 12 | PET | Flexterra | Xeri-scaping seed mixture | 0.175 | g/tray |
| | | | Meadow seed mixture | 0.175 | g/tray |
| 13 | PET | Fibramulch² | Xeri-scaping seed mixture | 0.35 | g/tray |
| 14 | PET | Fibramulch | Meadow seed mixture | 0.35 | g/tray |
| 15 | PET | Fibramulch | Xeri-scaping seed mixture | 0.175 | g/tray |
| | | | Meadow seed mixture | 0.175 | g/tray |
| 16 | PET | Fibramulch | Xeri-scaping seed mixture | 0.5 | g/tray |
| 17 | PET | Fibramulch | Meadow seed mixture | 0.5 | g/tray |
| 18 | PET | Fibramulch | Xeri-scaping seed mixture | 0.375 | g/tray |
| | | | Meadow seed mixture | 0.125 | g/tray |
| 19 | PET | Flexterra | Sedum mixture³ | 155.6 | g/tray (0.25 lb/ft²)** |
| 20 | PET | Flexterra | Sedum mixture | 77.8 | g/tray (0.125 lb/ft²) |
| 21 | PET | Flexterra | Little bluestem | 0.5 | g/tray |
| 22 | PET | Flexterra | Buffalo grass | 0.5 | g/tray |
| 23 | PET | Flexterra | Blue gramma | 0.5 | g/tray |
| 24 | PET | none⁴ | Buffalo grass | 0.5 | g/tray |

¹Flexterra carrier mixtures also contained 600 ml water.
²Fibramulch carrier mixtures also contained 900 ml water.
³Sedum mixture had Sedum kamtschaticum, Sedum reflexum, Sedum sexangulare and Sedum hybridum cuttings.
⁴250 mL of water was used in the treatment having no binding agent.
*All treatments used a woven polyethylene terephthalate mat having a thickness of about 0.5 cm.
**Recommended density.

TABLE 7

| | | Carrier Mixture | | | |
|---|---|---|---|---|---|
| No. | Carrier Mat | Binding Agent | Vegetation Propagation Material | Seed/Cutting Density | |
| 1 | PET (thin)* | Flexterra^{#} | Xeri-scaping seed mixture | 0.5 | g/mat |
| 2 | PET (thin) | Flexterra | Meadow seed mixture | 0.5 | g/mat |
| 3 | PET (thin) | Flexterra | Xeri-scaping seed mixture | 0.25 | g/mat |
| | | | Meadow seed mixture | 0.25 | g/mat |
| 4 | PET (thin) | Flexterra | Xeri-scaping seed mixture | 0.125 | g/mat |
| | | | Meadow seed mixture | 0.125 | g/mat |
| 5 | PET (thin) | Flexterra | Xeri-scaping seed mixture | 5 | g/mat |
| 6 | PET (thin) | Flexterra | Meadow seed mixture | 0.5 | g/mat |
| 7 | PET (thin) | Flexterra | Xeri-scaping seed mixture | 0.25 | g/mat |
| | | | Meadow seed mixture | 0.25 | g/mat |
| 8 | PET (thin) | Flexterra | Xeri-scaping seed mixture | 0.125 | g/mat |
| | | | Meadow seed mixture | 0.125 | g/mat |
| 9 | PET (thin) | Flexterra | Sedum mixture^{&} | 155.6 | g/mat (0.25 lb/ft²)^{###} |
| 10 | PET (thin) | Flexterra | Sedum mixture | 77.8 | g/mat (0.125 lb/ft²) |
| 11 | PET (thin) | Flexterra | Sedum mixture | 25 | g/mat |
| 12 | PET (thick)** | Flexterra | Sedum mixture | 155.6 | g/mat (0.25 lb/ft²)^{###} |
| 13 | PET (thick) | Flexterra | Sedum mixture | 77.8 | g/mat (0.125 lb/ft²) |
| 14 | PET (thick) | Flexterra | Sedum mixture | 25 | g/mat |
| 15 | PET (thin) | none^{##} | Xeri-scaping seed mixture | 0.25 | g/mat |
| | | | Meadow seed mixture | 0.25 | g/mat |
| 16 | PET (layered)*** | Flexterra | Xeri-scaping seed mixture | 0.25 | g/mat |
| | | | Meadow seed mixture | 0.25 | g/mat |
| 17 | PET (layered)**** | Flexterra | Xeri-scaping seed mixture | 0.25 | g/mat |
| | | | Meadow seed mixture | 0.25 | g/mat |
| 18 | PET (thick) | tackifier^{§} + H₂O | Xeri-scaping seed mixture | 0.5 | g/mat |
| 19 | PET (thick) | tackifier^{§} + H₂O | Meadow seed mixture | 0.5 | g/mat |
| 20 | PET (thin) | Flexterra | Little bluestem | 0.5 | g/tray |
| 21 | PET (thin) | Flexterra | Buffalo grass | 0.5 | g/tray |
| 22 | PET (thin) | Flexterra | Blue gramma | 0.5 | g/tray |
| 23 | PET (layered)*** | none | Little bluestem | 0.5 | g/tray |
| 24 | PET (layered)*** | none | Buffalo grass | 0.5 | g/tray |

*Woven polyethylene terephthalate mat having a thickness of about 0.5 cm.
**Woven polyethylene terephthalate mat having a thickness of about 1.0 cm.
***Both PET mats were thick (about 1 cm thick each).
****Both PET mats were thin (about 0.5 cm thick each).
^{#}In Flexterra treatments, the carrier mixture also contained about 600 ml water.
^{##}250 mL of water was used in the treatments having no binding agent.
^{###}Recommended density.
^{§}About 4 g Polyacrylamide particles (particle size less than about 0.3 mm) and about 3 g organic glue (plantago) suspended in about 750 ml water. A water-soluble fertilizer was also added to the carrier mixture.
^{&}Sedum mixture had Sedum kamtschaticum, Sedum reflexum, Sedum sexangulare and Sedum hybridum cuttings.

TABLE 8
Species combinations expressed as a percent mass of total seed
mixture used in Trial 4

| | Combo | Combo |
|---|---|---|
| Common name (species) | 1 (%) | 2 (%) |
| Black Eyed Susan (Rudbecki hirta) | 10 | 5 |
| Bachelor Buttons (Centaurea cyanus) | 5 | 5 |
| California Poppy (Eschscholtzia rhoes) | 10 | 5 |
| Scarlet Flax (Linum grandiflorum) | 10 | 10 |
| Lance Leaf Coreopsis (Coreopsis lanceolata) | 10 | 10 |
| Dwarf Plains Coreopsis (Coreopsis tinctoria) | 10 | 10 |
| Wild Lupine (Lupine perennis) | 10 | 10 |
| Yellow Prairie Coneflower (Ratibida columnifera) | 5 | |
| White Yarrow (Achillea millifolium) | 2.5 | |
| Rocky Mountain Penstemon (Penstemon strictus) | 10 | 20 |
| Canada Wild Rye (Elymus canadensis)* | 5 | 5 |
| Little Bluestem (Schizachyrium scoparium) | 7.5 | 15 |
| Alpine Aster (Aster alpines)* | 5 | 5 |

*Species present in mixture which were not tested in Trials 1-3.

TABLE 9
Vegetation propagation material mixtures used for Trial 5

| Seed/cutting | Combo 1 | Combo 2 | Combo 3 | Combo 4 | Combo 5 | Combo 6 | Combo 7 |
|---|---|---|---|---|---|---|---|
| Sheep's Fescue | | | | 10 | | | |
| Evening Scented Primrose | | | | 10 | 10 | | |
| Hard Fescue | 20 | 33.3 | | 10 | | | |
| Black Eyed Susan | 20 | | 10 | 10 | 10 | 10 | |
| Bachelor Buttons | | | 10 | 10 | | 10 | |
| California Poppy | | | 10 | 10 | | 10 | |
| Scarlet Flax | 20 | | | 10 | | | |
| Lance Leaf Coreopsis | 20 | | 10 | 10 | 10 | 10 | |
| Dwarf Plains Coreopsis | | | 10 | | 10 | 10 | |
| Wild Lupine | | | | 10 | | | |
| Yellow Prairie Coneflower | | | 10 | 10 | | 10 | |
| White Yarrow | | | | | 10 | | |
| Rocky Mountain Penstemon | | 33.3 | 10 | | | 10 | |
| Canada Wild Rye | 20 | | | | | | |
| Little Bluestem | | | 10 | | | 10 | |
| Alpine Aster | | 33.3 | 10 | | | 10 | |
| Buffalo Grass | | | 10 | | 10 | 10 | 100 |
| Common Milkweed | | | | | 10 | | |
| Hoary Vervain | | | | | 10 | | |
| Sand Dropseed | | | | | 10 | | |
| Ticklegrass | | | | | 10 | | |
| Sedum album | | 2.5 g | | | | 2.5 g | 4 g |
| Sedum reflexum | | 2.5 g | | | | 2.5 g | 4 g |
| Sedum sexangulare | | 2.5 g | | | | 2.5 g | 4 g |
| Sedum kamtschaticum | | 2.5 g | | | | 2.5 g | 4 g |
| Sedum spurium | | 2.5 g | | | | 2.5 g | 4 g |

1.-4. (canceled)

5. A process for producing a pre-vegetated mat, comprising:
depositing a carrier mixture comprising vegetation propagation material suspended in an aqueous solution comprising a tackifying agent and a water-absorbing polymer on a carrier mat that does not degrade under exterior growing conditions; and
subjecting the carrier mixture on the carrier mat to hydroponic growing conditions,
wherein the pre-vegetated mat is soilless.

6. (canceled)

7. The process of claim 5, wherein the vegetation propagation material is vegetation seeds.

8. The process of claim 5, wherein the vegetation propagation material is vegetation cuttings.

9. The process of claim 7, wherein the vegetation seeds are seeds from one or more of a meadow seed mixture, a drought tolerant seed mixture, a Sedum mixture and grass seeds.

10. (canceled)

11. (canceled)

12. The process of claim 5, wherein the carrier mixture further comprises a water-soluble fertilizer.

13. The process of claim 12, wherein the water-soluble fertilizer comprises a source of nitrogen, a source of phosphorous, a source of potassium, and trace amounts of sources of one or more micronutrients.

14. The process of claim 5, wherein the tackifying agent is an organic glue.

15. The process of claim 5, wherein the tackifying agent is a polyacrylamide having a particle size of less than about 0.3 mm.

16. The process of claim 5, wherein the water-absorbing polymer is a polyacrylamide having a particle size of about 0.3 mm to about 2 mm.

17. The process of claim 5, wherein the carrier mixture further comprises one or more types of fibers.

18. The process of claim 17, wherein the fibers are synthetic fibers.

19. The process of claim 18, wherein the synthetic fibers are polyethylene terephthalate fibers.

20. (canceled)

21. The process of claim 19, wherein the polyethylene terephthalate is a woven polyethylene terephthalate.

22. The process of claim 5, wherein the hydroponic growing conditions comprise:
supplying water and water-soluble fertilizer from a nutrient and water reservoir to an irrigation area housing the carrier mixture on the carrier mat;
collecting excess water and water-soluble fertilizer back in the nutrient and water reservoir; and
repeating the steps of supplying the water and water-soluble fertilizer to the irrigation area, and collecting the excess water and water-soluble fertilizer back in the nutrient and water reservoir until the soilless pre-vegetated mat is produced.

23. The process of claim 22, wherein a waterproof membrane is under the carrier mat in the irrigation area.

24. The process of claim 22, wherein a raised berm barrier surrounds the irrigation area.

25. The process of claim 22, wherein the water and water-soluble fertilizer are supplied from the nutrient and water reservoir to the irrigation area using an irrigation system.

26. The process of claim 22, wherein the irrigation area has an opening which drains the excess water and water-soluble fertilizer into the nutrient and water reservoir.

27. The process of claim 26, wherein the irrigation area has a further opening which redirects excess water and water-soluble fertilizer outside of the irrigation area when the nutrient and water reservoir has reached full capacity.

28. The process of claim 25, wherein the irrigation system supplying the water and water-soluble fertilizer to the irrigation area from the nutrient and water reservoir is controlled by an irrigation control and pump.

29. (canceled)
